(19) United States
(12) Patent Application Publication
(10) Pub. No.: US 2009/0216602 A1
(43) Pub. Date: Aug. 27, 2009

(54) Schedule Analyzer

(76) Inventor: Mark E. Henderson, Kingwood, TX (US)

Correspondence Address: Exxon Mobil Upstream;Research Company, P.O. Box 2189, (CORP-URC-SW 359), Houston, TX, 77252-2189, US

(21) Appl. No.: 12/341,899

(22) Filed: Dec. 22, 2008

Related U.S. Application Data
(60) Provisional application No. 61/066,548, filed on Feb. 21, 2008.

(51) Int. Cl. G06Q 10/00; G06Q 50/00

(52) U.S. Cl. 705/9; 705/8; 705/11

(57) ABSTRACT

A project schedule is managed by developing a float profile area chart having a float profile with a float gradient for at least one non-completed activity within the project schedule to pictorially assess schedule viability. A schedule risk index (SRI) score is calculated to qualitatively assess a risk level associated with the project schedule. Schedule quality metrics are measured and the values for the metrics aggregated to provide an indication of the project schedule being manipulated by a scheduler. Historical trends for the schedule quality metrics are trended across at least two update intervals, and schedule performance is also measured, e.g., by trending early starts and early finishes for the project and a relative slippage occurring from the across schedule updates.

### CROSS-REFERENCE TO RELATED APPLICATION

This application claims the benefit of U.S. Provisional Patent Application 61/066,548 filed 21 Feb. 2008 entitled SCHEDULE ANALYZER, the entirety of which is incorporated by reference herein.

### TECHNICAL FIELD

This description relates generally to the field of project schedule management. Specifically, this description relates to systems and methods for measuring and characterizing project schedule parameters, such as schedule quality, schedule performance, and historical trending, e.g., for the planning of field development and production of a hydrocarbon bearing resource.

### BACKGROUND

Existing methods of analyzing schedules rely heavily on an individual scheduler's experience and specific talent in this area. For example, a typical focus of schedule analysis is centered on critical path activities, e.g., developed via a Critical Path Method (CPM) for scheduling. However, often CPM analysis is not sufficient to fully gauge the status of a project for various reasons. For example, computing software typically relies upon data and information contained within the electronic model and does not makes any allowance for schedule quality issues.

Current methods and systems may also provide distorted data and information when the electronic model has inherent quality issues, e.g., missing logic, or excessive constraints. Further, existing systems and methods typically do not provide a fast and effective method to judge the quality of the schedule by highlighting deficiencies that prohibit the scheduling software model from providing its intended function.

The present inventor has determined that existing practices do not provide systems and methods to adequately assess the viability of a schedule, to adequately trend historical schedule performance and quality issues, and/or to qualitatively assess schedule risk.

### SUMMARY

In one general aspect, a method for managing a project schedule includes developing a float profile area chart having a float profile with a float gradient for at least one non-completed activity within the project schedule to pictorially assess schedule viability. A schedule risk index (SRI) score is calculated to qualitatively assess a risk level associated with the project schedule. Changes from a recent schedule update relative to a previous schedule update are compared based on a plurality of weighted factors to tabulate the SRI score, the SRI score being indicative of risk the project schedule will miss a scheduled completion date. Schedule quality metrics are measured and the values aggregated for the metrics to provide an indication of the project schedule being manipulated by a scheduler. Historical trends are recorded for the schedule quality metrics and weighted factors across at least two update intervals. Schedule performance is measured by trending early starts and early finishes for the project and trending a relative slippage occurring from the previous schedule update to the recent schedule update.

Implementations of this aspect may include one or more of the following features. For example, the float gradient may be a measure of a number of days an activity may miss a target deadline prior to impacting a scheduled completion of the project schedule. The float profile area chart may include a first axis defining positive and negative float gradients and a second axis defining a number of activities defined along a second axis of the area chart. The float profile area chart may include a float profile having all non-completed activities plotted against float gradient, the float gradient including a positive float gradient range expressed from 1 to 1,000 days, a mid-point of zero days float, and negative gradient range expressed from −1 to −1,000 days. The float profile area chart may include displaying a float profile for a current period and a float profile for a target period. The float profile area chart may be developed by displaying a float profile for a historical period and a float profile for a current period. The float profile area chart may include float profiles for activities grouped by activity type and/or a float profile for each of at least three time periods during the project schedule.

The SRI score is a schedule risk index score within a range of 0 to 100, wherein a schedule risk index score of 100 corresponds to a highest risk of the project schedule missing a scheduled completion date. The schedule risk index score may be displayed in a graphical report along with the float area profile chart. The weighted factors may include one or more, e.g., between one to eleven, of the factors selected from the group consisting of (i) Early Start (ES) date slippage expressed in terms of percentage of remaining activities; (ii) Severity of ES slippage expressed in terms of average number of ES days with respect to days in the period; (iii) Early Finish (EF) date slippage expressed in terms of percentage of remaining activities; (iv) Severity of EF slippage expressed in terms of average number of EF days with respect to days in the period; (v) Percentage of remaining activities having 50 or fewer days of float; (vi) Percentage of remaining activities having less than or equal to 0 days of float; (vii) Percentage of logic changes changed in the period with respect to total logic ties; (viii) Criticality expressed in terms of negative float; (ix) percentage of duration increases of remaining activities; (x) Average number of days of duration increases with respect to days in the period; and (xi) Percentage of constrained activities associated with the schedule bypassing mathematical calculations. For example, the weighted factors may include three to eleven of factors (i) through factors (xi), e.g., such as all eleven of factors (i) through (xi). The weighted factors can be determined by multiplying values associated with factors (i) through (xi) by the following weighting percentages (i) 10%; (ii) 5%; (iii) 10%, (iv) 5%; (v) 15%; (vi) 10%; (vii) 10%; (viii) 10%, (ix) 10%; (x) 5%; and (xi) 10%, respectively.

The SRI score can be displayed for each schedule update on at least one report, wherein the at least one report also includes one or more of a float area profile chart, measured schedule quality metrics, recorded historical trends for the schedule quality metrics, early starts and early finishes for the project, and/or a relative slippage occurring from the previous schedule update to the recent schedule update. Measures of schedule quality are identified by measuring at least one of the metrics selected from the group consisting of (i) Activity Duration Changes; (ii) Progress Reported to a Non-Started Activity; (iii) Recording an Actual Start/Finish after the schedule Data Date; (iv) Recording 100% progress to an Incomplete Activity; (v) Number of Added or Deleted Activities; (vi) Number of Revised Activity Descriptions; (vii) Number of Logic Changes; (viii) Number of Calendar Changes; (ix) Number of Actual Start Changes; and (x) Number of Actual Finish Changes. The metrics include all ten of metric (i) through metric (x).

The project schedule can be updated during at least three project schedule updates. The schedule quality metrics can then be measured at each project schedule update. Changes in the project schedule quality are tracked over time, and a tabular report indicative of changes in the project schedule at each project schedule update is generated. One or more of the following metrics selected from the group consisting of: (i) number of added or deleted activities; (ii) number of logic changes; (iii) activity duration changes; (iv) average of duration increase; (v) schedule risk index (SRI); (vi) total float (maximum); (vii) average float; (viii) minimum float; (ix) total activities in the schedule versus remaining activities to complete; and (x) grouping of near critical activities by float ranges, is/are captured at each of the at least three project schedule updates and generated in the tabular report. One or more of the following metrics are captured at each of the at least two project schedule updates and generated in the tabular report: (i) early starts (ES); and early finishes (EF). 22. The project schedule may be associated with one or more of field development and/or a production schedule for the production of hydrocarbons from a subsurface formation.

In another general aspect, a tangible computer-readable storage medium having embodied thereon a computer program configured to, when executed by a processor, manage a project schedule. The tangible computer-readable storage includes one or more code segments configured to develop a float profile area chart having a float profile with a float gradient for at least one non-completed activity within the project schedule to pictorially assess schedule viability; calculate a schedule risk index (SRI) score to qualitatively assess a risk level associated with the project schedule, wherein calculating the schedule risk index score includes comparing changes from a recent schedule update relative to a previous schedule update based on a plurality of weighted factors to tabulate the SRI score, the SRI score being indicative of risk the project schedule will miss a scheduled completion date; measure a plurality of schedule quality metrics and aggregating the values for the metrics to provide an indication of the project schedule being manipulated by a scheduler; record historical trends for the schedule quality metrics and weighted factors across at least two update intervals; and measure schedule performance by trending early starts and early finishes for the project and a relative slippage occurring from the previous schedule update to the recent schedule update.

Implementations of this aspect may include one or more of the following features. For example, the tangible computer-readable storage medium may include one or more code segments configured to update the project schedule during at least three project schedule updates, and to measure the schedule quality metrics at each project schedule update. The tangible computer-readable storage medium may include one or more code segments configured to track changes in the project schedule quality over time; and to generate a tabular report indicative of changes in the project schedule at each project schedule update.

In another general aspect, a system for managing a project schedule includes a processor; a display unit operatively coupled to the processor; and a memory operatively coupled to the processor. The processor is configured to develop a float profile area chart having a float profile with a float gradient for at least one non-completed activity within the project schedule to pictorially assess schedule viability through the display unit; calculate a schedule risk index (SRI) score to qualitatively assess a risk level associated with the project schedule, wherein calculating the schedule risk index score includes comparing changes from a recent schedule update relative to a previous schedule update based on a plurality of weighted factors to tabulate the SRI score, the SRI score being indicative of risk the project schedule will miss a scheduled completion date; measure a plurality of schedule quality metrics and aggregating the values for the metrics to provide an indication of the project schedule being manipulated by a scheduler; record historical trends for the schedule quality metrics and weighted factors across at least two update intervals; and measure schedule performance by trending early starts and early finishes for the project and a relative slippage occurring from the previous schedule update to the recent schedule update.

### BRIEF DESCRIPTION OF THE DRAWINGS

FIG. 1A is a screenshot of a graphical user interface for an exemplary schedule analysis system of the background art.

FIG. 1B is a screenshot of a graphical user interface for a report generation component of an exemplary schedule analysis system of the background art.

FIG. 2A is a graphical view of project performance over the course of a project schedule showing a number of activities compared to project delays.

FIG. 2B is a graphical view of average project delay (and minimum total float) shown with respect to the number of days in a period.

FIG. 3 is a graphical view of an exemplary float profile area chart of the background art showing a float profile for a current period compared against a float profile for a previous project schedule.

FIG. 4 is a graphical view of an exemplary schedule risk index (SRI) analysis of the background art showing schedule risk index score throughout the course of a project schedule.

FIG. 5 is a screenshot of a schedule manipulation report of the background art showing exemplary matrices for schedule manipulation techniques.

FIG. 6 is a screenshot of an exemplary executive summary report of the background art showing early date schedule realization, realized average delay versus criticality, a remaining activities float profile, project activity status, missing logic ties, and a results section.

FIG. 7 is a screenshot of the results section of FIG. 6.

FIG. 8 is a flowchart of an exemplary process for analyzing a project schedule according to an embodiment of the present invention.

FIG. 9A is a screenshot of a graphical user interface for a data import component of an exemplary schedule analysis system according to an embodiment of the present invention.

FIG. 9B is a screenshot of an exemplary graphical user interface of a schedule performance component of a schedule analysis system according to an embodiment of the present invention.

FIG. 9C is a screenshot of an exemplary graphical user interface of a schedule quality component of a schedule analysis system according to an embodiment of the present invention.

FIG. 10 is a screenshot of an exemplary executive summary report containing a schedule performance chart, tabular chart of historical performance statistics, and a float profile historical comparison chart.

FIG. 11 is an exemplary float profile historical comparison chart.

FIG. 12 is an exemplary schedule performance chart.

FIG. 13 is an exemplary tabular chart of historical performance statistics.

FIG. 14 is a screenshot of exemplary float criticality charts showing early date realization versus a number of activities and early date realization and average change versus criticality.

FIG. 15 is a screenshot of an exemplary float profile historical comparison shown with a date filter option window.

FIG. 16 is a screenshot of an exemplary tabular chart containing calculations for schedule risk index (SRI).

FIG. 17 is a screenshot of an exemplary float profile chart for remaining activities plotted according to various work groups.

FIG. 18 is a schematic view of an exemplary schedule analysis system.

### DETAILED DESCRIPTION

The techniques presented hereinafter generally relate to the analysis of project schedules. Often CPM analysis is not sufficient to fully gauge the status of a project for various reasons. Computing software relies on the data and information contained within the electronic model and often does not make sufficient allowance for quality issues. Current methods and systems of the background art may also provide distorted data and information when the electronic model has inherent quality issues, e.g., such as missing logic, schedule manipulation, and/or excessive constraints. The present inventor has determined that existing systems and methods do not provide a fast and effective method to judge the quality of the schedule by highlighting deficiencies that prohibit the scheduling software model from providing its intended function. In addition, existing practices do not provide systems and methods to adequately assess the viability of a schedule, trend historical schedule performance and quality issues, and/or qualitatively assess schedule risk. Several software products are available which provide a detailed comparison that identifies specific changes from one schedule to another, but these systems typically rely on the individual scheduler's talent. Accordingly, the existing systems and methods are particular susceptible to schedule manipulation and shortcomings initiated by the individual scheduler.

One or more embodiments of the present invention provide systems and methods which address one or more of schedule quality, schedule performance, historical trending, and other statistical quantitative performance. Additionally, one or more systems and methods of the present invention provide functionality for pictorially assessing schedule viability and/or qualitative schedule risk assessment.

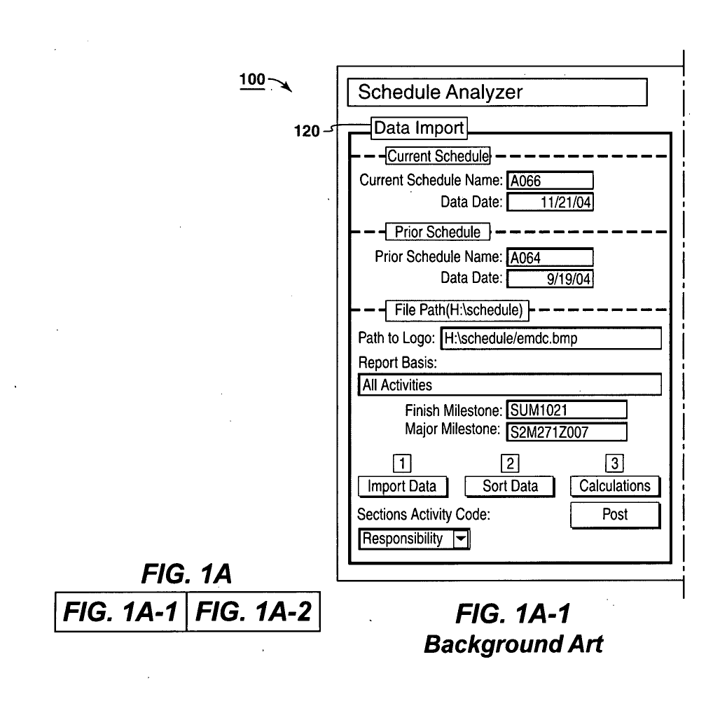

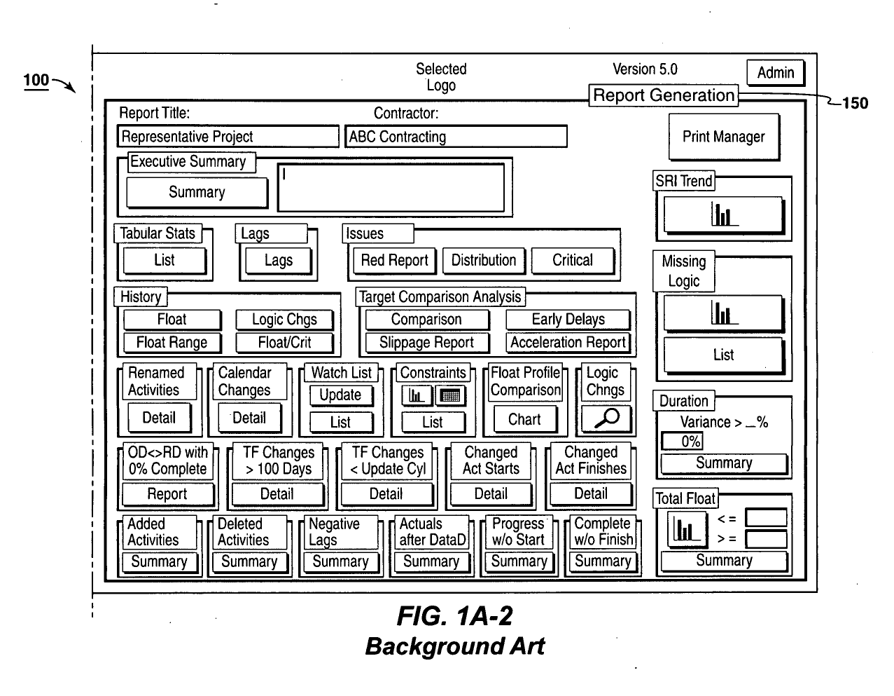

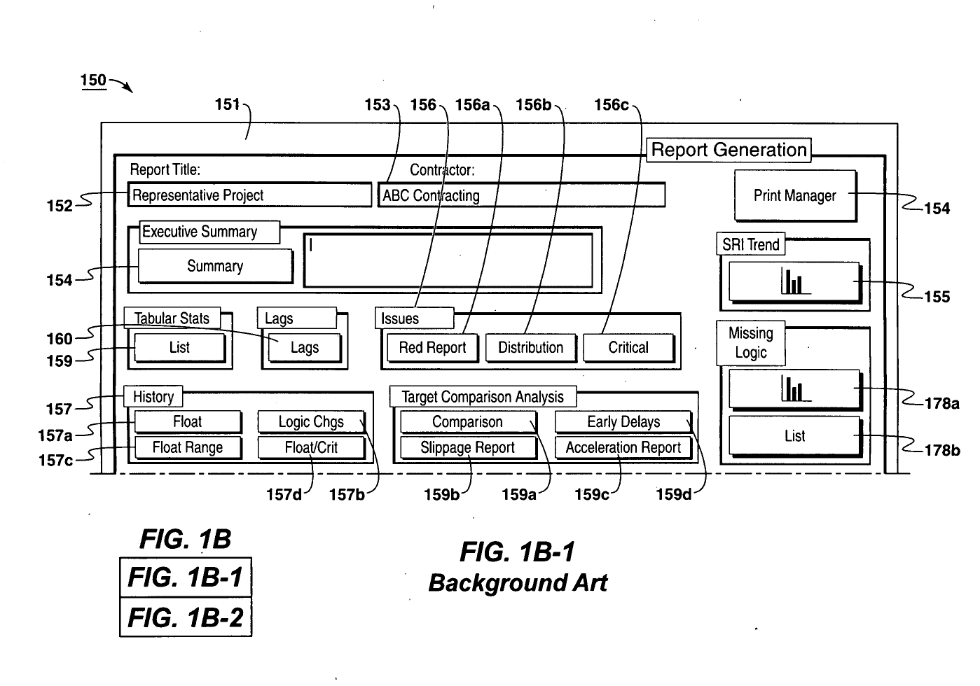

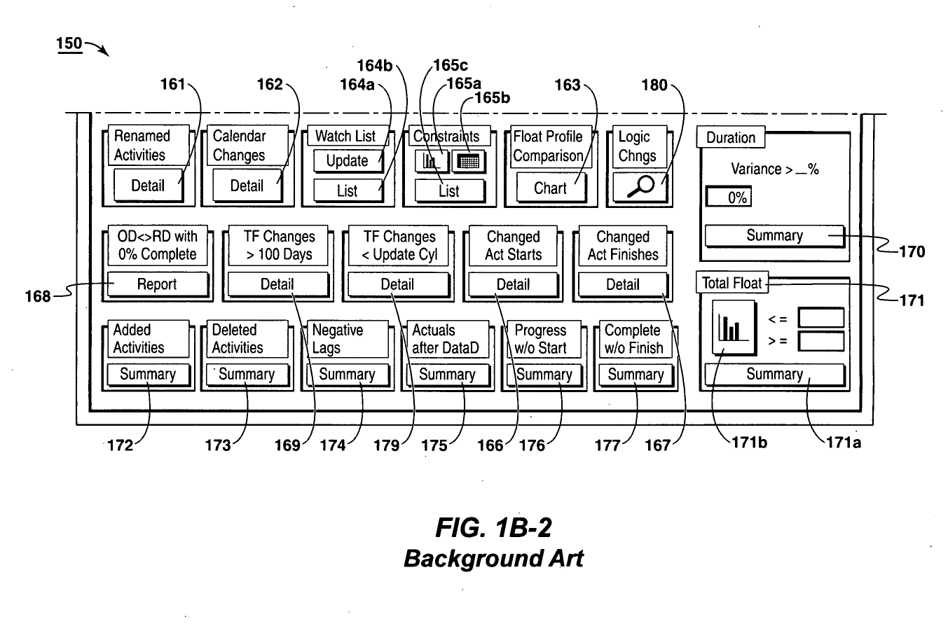

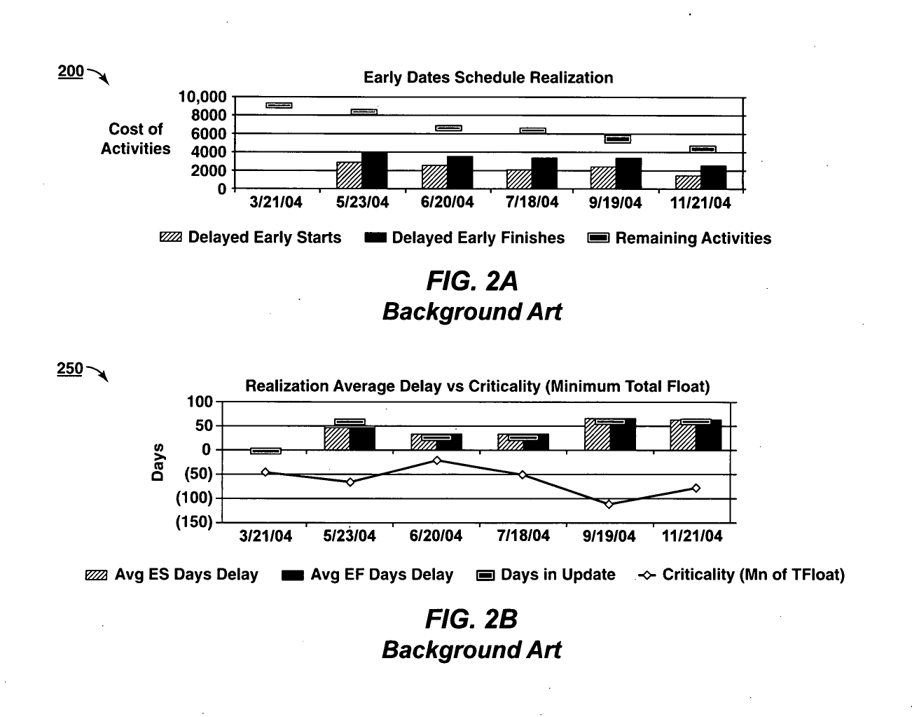

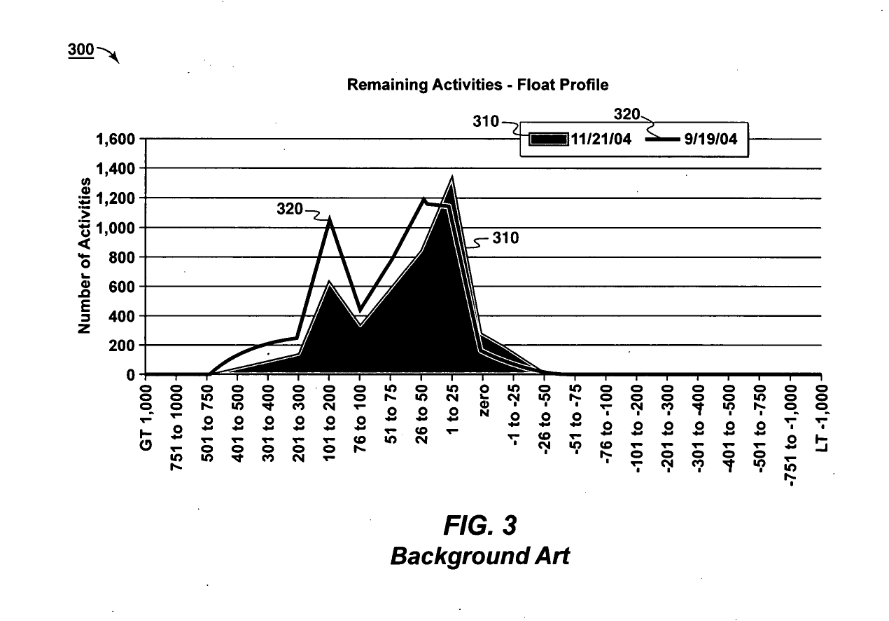

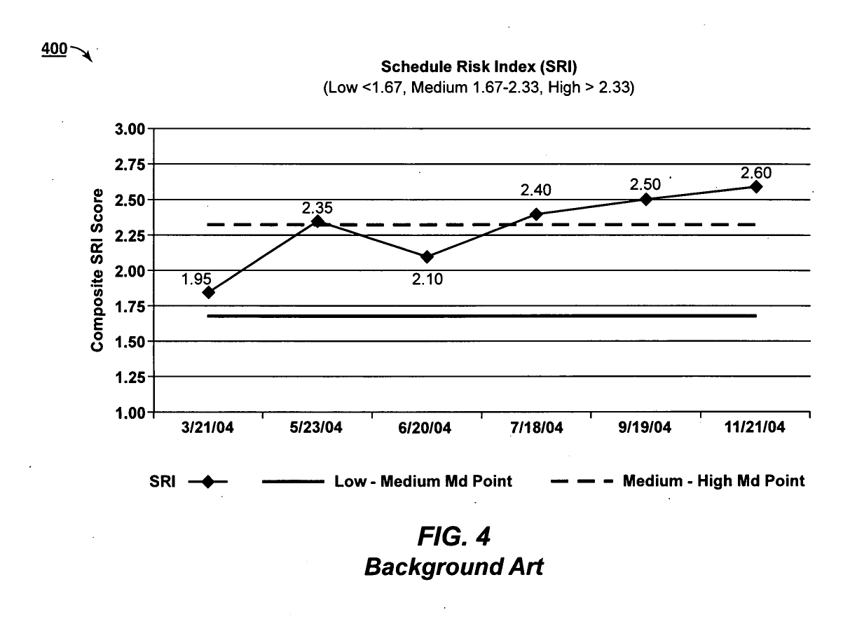

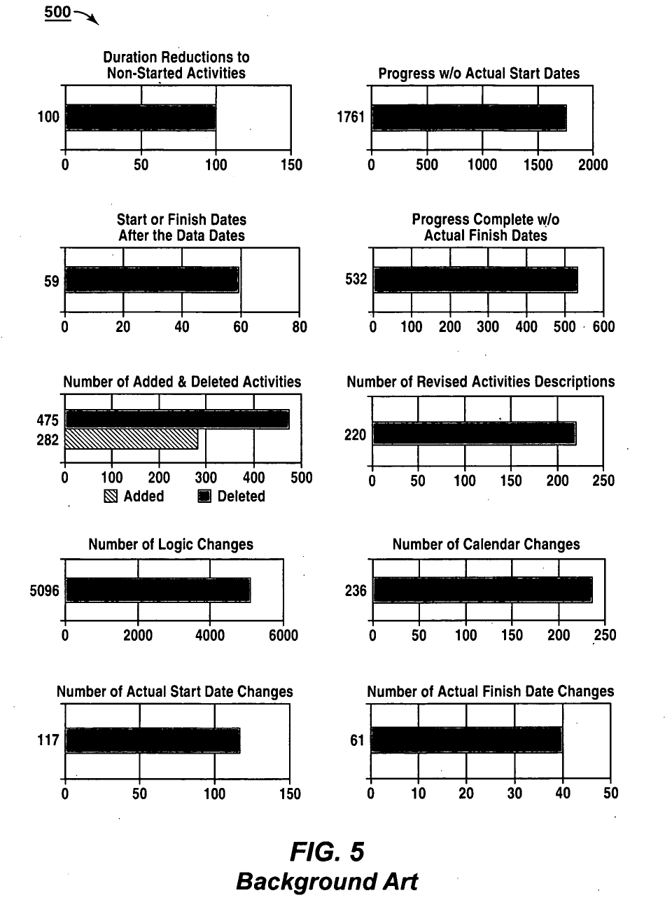

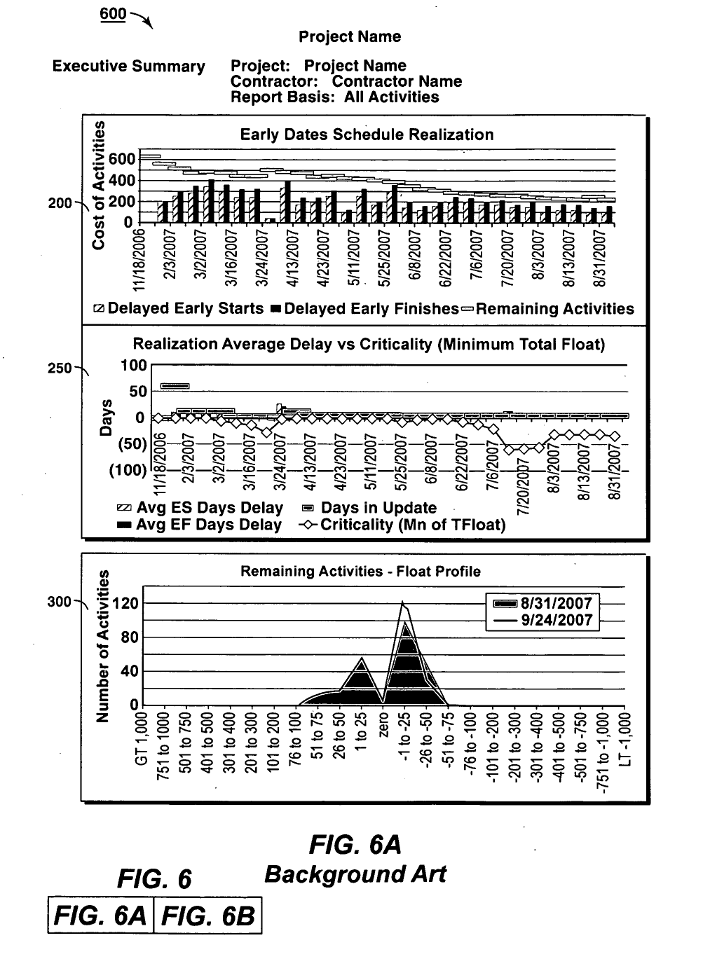

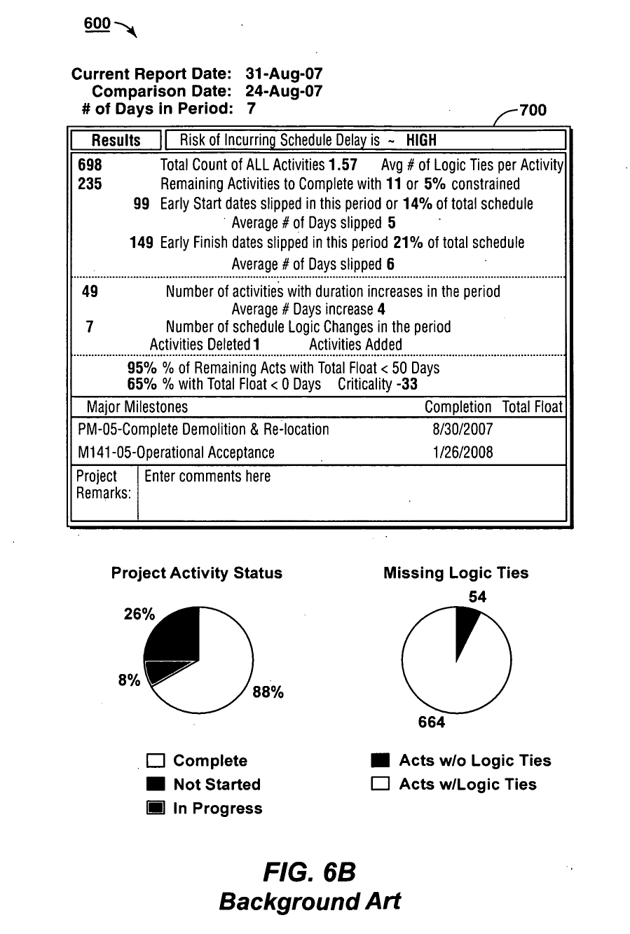

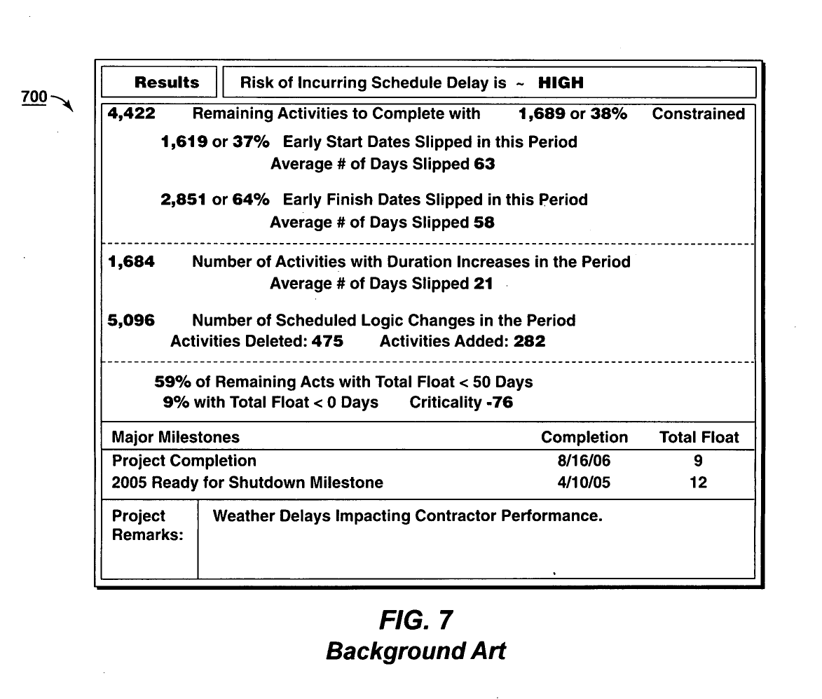

Referring to FIGS. 1A-1B through FIG. 7, an exemplary schedule analysis system 100 of the background art includes various component features which provide various aspects of schedule quality analysis. In general, the system 100 includes the ability to assess schedule viability via a float profile method, to calculate schedule risk index scores, e.g., qualitative risk assessment, and to assess schedule quality, e.g., identifying measures of schedule quality. For example, FIG. 1A is a screenshot of a graphical user interface 110 for the exemplary schedule analysis system 100 of the background art. FIG. 1B is a screenshot of the graphical user interface 150 for a report generation component of the exemplary schedule analysis system 100 of the background art. FIG. 2A is a graphical view of project performance over the course of a project schedule in a chart 200 showing a number of activities compared to project delays. FIG. 2B is a graphical view of average project delay (and minimum total float) shown in a chart 250 with respect to the number of days in a period. FIG. 3 is a graphical view of an exemplary float profile area chart 300 of the background art showing a float profile for a current period compared against a float profile for a previous project schedule. FIG. 4 is a graphical view of an exemplary schedule risk index (SRI) analysis plot 400 of the background art showing schedule risk index score throughout the course of a project schedule. FIG. 5 is a screenshot of a schedule manipulation report 500 of the background art showing exemplary matrices for various, exemplary schedule manipulation techniques. FIG. 6 is a screenshot of an exemplary executive summary report 600 of the background art showing early date schedule realization, realized average delay versus criticality, a remaining activities float profile, project activity status, missing logic ties, and a results section. FIG. 7 is a screenshot of the results section 700 of FIG. 6.

Referring to FIG. 1A, the graphical user interface 110 includes a data import section 120 and a report generation section 150. The data import section 120 and the report generation section 150 each include various fields and/or preconfigured radio buttons which permit the user to input and/or view data relating to data importation, e.g., current and past schedules, file path, date ranges, and report generation, e.g., various tables, plots and charts. Referring to the import section 120, an exemplary data import process allows the import of a “current schedule” and a “prior schedule” in order to compare the schedules as well as analyze the stability and logic of the schedule. Before starting import process, the user may also designate the “Current Schedule Name” and the current “Data Date,” and “Prior Schedule Name” and the prior “Data Date.” The user may also designate logos, e.g., “Path to Logo,” the “Report Basis,” activity IDs for the “Finish Milestone” and the “Major Milestone.” Once any calculations are complete, the posting of schedule data is complete, and the import process is finished.

Referring to FIG. 1B, the report generation section 150 of the use interface 110 includes various reporting options for viewing and analyzing scheduling data. A report header section 151 includes a Report Title field 152 for entering the title of the report and a Contractor field 153 for entering the contractor whose schedule will be analyzed, e.g., the contractor name appears along with the report title in the header of any generated report. One or more of the following radio buttons may also be included in the report generation section 150 for generating reports with various features in response to being selected by the system user. For example, reports are produced by clicking chart, detail or summary buttons. With respect to the user interface, a report is producible in several ways when multiple button options exist. When only one button is provided, the report is producible in only one way. An Executive Summary button 154 generates an executive summary report providing an overview of the basic project graphs and statistics. The executive summary report contains a Results section 700 (FIG. 7) that gives major statistics relating to the schedule, and a schedule risk index (SRI) rating. In addition, the user is provided with a field for entering project remarks, e.g., for commenting on the project schedule.

Referring to FIG. 6, an exemplary executive summary report 600 includes early dates schedule realization, such as chart 200, a realization average delay versus criticality (minimum total float) chart 250, a float profile 300, a results section 700, (see FIG. 7), and pie charts showing project activity status and missing logic ties. The project activity status chart shows the progression of the project and the work that remains to be completed. The missing logic chart shows whether logic ties are present in the schedule. In the example shown, there are minimal open ends, 54 acts without logic ties versus 644 acts with logic ties, which means that there is logic present. However, this does not necessarily mean that the proper logic is there. Referring to FIG. 7, the results section 700 provides useful statistics that schedule analyzer calculates. The results section 700 is a numerical summary of schedule analyzer's results, e.g., the SRI is displayed at the top as either “LOW,” MEDIUM,” or “HIGH,” and “Project Remarks” are displayed in this section as well.

Referring to FIG. 3, an exemplary float profile area chart 300 shows the comparison of the float profile in the current period (blue) 310 to the prior schedule (red) 320. In this case, there is an evident shift in the float towards the negative. In the current period 310, activities are slipping and the schedule is in danger of experiencing increasing negative float. Float, or slack, is a measure of how many days an activity may slip prior to impacting the scheduled completion. One benefit of float profiles is that the profiles show whether activities have too much float or too little float compared to the project stage. The profiles show whether the float for activities is becoming more or less negative, as well as the number of activities that may have too much float. Activities that show increases in negative float indicate that the scheduled project completion date is in jeopardy, while activities with large numbers of positive float may indicate the absence of schedule logic. Specifically, activities with high levels of float probably do not have the correct logic ties to predecessors or successors, e.g., a characteristic of poor scheduling technique.

Referring to FIG. 1B, an SRI Trend button 155 produces a schedule risk index (SRI) historical trend graph. For example, referring to FIG. 4, the SRI can be plotted in an SRI chart 400 that provides a qualitative indicator of the risk of schedule delay. The SRI evaluates the schedule quality, extent of changes and/or manipulations in the schedule components, performance relative to plan, and the stability of the plan. The risk numbers range from 1.00-3.00, with 1.00-1.66 being Low risk, 1.66-2.33 Medium risk, and 2.33-3.00 High risk. The SRI graph shows the trend of this risk over the course of the project. In chart 400, the risk is increasing over the project life.

Referring to FIG. 1B, an Issues Reports section 156 includes three buttons 156a, 156b, 156c for generating three graphs that show areas of concern for the overall schedule stability and structure. For example, a Red Report button 156a provides a one-page schedule manipulation report 500 covering the structural changes to the schedule that indicate changes and potential manipulation. Referring to FIG. 5, an exemplary schedule manipulation report 500 provides several matrices 510-555 for various schedule manipulation techniques employed by a scheduler to manipulate a schedule file to achieve desired outcomes. The manipulation by the scheduler may be used to hide or camouflage schedule problems. For example, the matrices may include one or more of the following, including duration reductions to non-started activities 510, progress without actual start date 515, start or finish dates after the data date 520, progress complete without actual finish date 525, a number of added and deleted activities 530, number of revised activities descriptions 535, number of logic changes 540, number of calendar changes 545, number of actual start date changes 550, and/or number of actual finish date changes 555.

A Distribution button 156b provides a graphic showing the schedule activity distribution by category. A Criticality button 156c produces a chart showing the criticality (min total floats). For example, referring to FIG. 2A, a schedule is intended to be an electronic model that represents the work to be accomplished and is expected to be constructed as an accurate representation of the scope of work incorporating all of the necessary interdependencies between activities. However, a schedule model may arrive as a snapshot with minimal or even incorrect, interdependent logic. An Early Dates Schedule Realization (Following the Plan) chart 200 shows schedule performance over the project life, e.g., how well the plan is being followed, by indicating delays compared to remaining activities. Referring to FIG. 2B, an Average Delay vs. Criticality chart 250 shows the magnitude of the average delay compared to the number of days in each period. As shown in the Schedule Realization chart 200, a large number of activities have been delayed. The Average Delay vs. Criticality chart 250 includes the minimum total float (criticality) as well.

Referring to FIG. 1B, a History section 157 includes history buttons 157a-157d which each enable the capture and trending over time of high level summary statistics. For example, a Float button 157a produces a graphical report that tracks free float over time. A Logic Changes button 157b displays a graphic that counts activities that are missing logic over time. A Float Range button 157c provides a graphical report showing maximum, minimum, and average total float for each successive update. A Float/Criticality button 157d provides a graphic of the number of delayed activities along with the criticality.

A Target Comparison Analysis section 158 includes four buttons 158a-158d for providing four reports focused on schedule performance, e.g., derived from comparing the current schedule against a “target” schedule. For example, a Comparison button 158a provides a statistical tabular report categorized by a Sections Activity Code. A Slippage Report button 158b and Acceleration Report button 158c produce tabular listings of activity information. The information contained in each report is based on data entered on their secondary screens, e.g., Slippage Form: Form; and Acceleration Form: Form, respectively, that display following the button selection. An Early Delays button 158d produces a graphic focused on schedule realization and schedule performance gauging the early schedule start and finish dates. The number of days of schedule slippage for each date field is entered to specify the output of the Slippage or Acceleration report. A negative number is entered for slippage and a positive number for acceleration.

Referring to FIG. 1B, a Tabular Stats button 159 provides a summary statistical chart and a Lags button 160 produces a report that lists the current, prior and delta of the lags for all activities. A Renamed Activities button 161 provides a tabular listing of the activities that have description changes from one schedule to another. A Calendar Changes button 162 provides a tabular listing of the activities that have calendar changes from one schedule to another. A Float Profile Comparison button 163 provides a float profile area chart comparing the current float profile versus the comparison schedule. A Watch List section 164 includes two buttons 164a, 164b which each allow for the tracking of certain activities, e.g., an Update button 164a brings up a screen to enter the Activity ID of the activities to be tracked and a List button 164b provides a report of these activities. A Constraints section includes three buttons 165a-c that each provides data regarding imposed constraints applied to the schedule activities. For example, a chart button 165a, category summary button 165b, and list button 165c are provided. A Changed Activity Starts button 166 provides a tabular listing of the activities that have calendar changes from one schedule to the other. A Changed Activity Finishes button 167 provides a tabular listing of the activities that have calendar changes revised from one schedule to the other.

Referring to FIG. 1B, an Original Duration not equal to Remaining Duration and not Started button 168 provides a tabular listing of the activities where the original duration is not equal to the remaining duration and the activity has not yet started. A Total Float Changes greater than One Hundred Days button 169 provides a tabular report listing the activities and their current total float versus prior “target” float and the variance in calendar days. The report is truncated to only list those activities with a float variance greater than one hundred days. A Duration Summary button 170 provides a tabular report showing duration variances. The user inputs the percent of duration for selection criteria in the input form, then selects the Duration Summary button 170 to produce the desired report. A Total Float section 171 provides a tabular report Summary button 171a and a graphic Chart button 171b which each focus on duration variances. The percent of duration is entered for selection criteria in the input form, and the user then selects the Summary button 171a to produce a tabular summary. The Chart button 171b produces a graphic area chart and ignores the criteria in the input form. An Added Activities button 172 provides tabular reports focused on added activities. A Deleted Activities button 173 provides tabular reports focused on deleted activities. A Negative Lags button 174 provides a tabular report focused on the activities with negative lag values in the logic string.

An Actuals After the Data Date button 175 provides tabular reports focused on activities with actual start or finish dates later than the schedule data date. A Progress without an Actual Start button 176 provides tabular reports focused on activities with progress entered but without actual start dates. A Complete without an Actual Finish button 177 provides tabular reports focused on activities with progress completed but no actual finish dates. A Missing Logic section 178 provides two reports. A missing logic Chart button 178a provides a graphic reflecting each area of the schedule and the percent of activities that are missing logic. The missing logic List button 178b provides a tabular report. A Total Float Changes <The Update Cycle button 179 provides a tabular listing of all activities where the total float variance is less than the number of days in the update cycle. This report reflects float acceleration, or activities that are becoming more critical in nature. A Logic Changes button 180 provides a tabular listing of all logic changes between the schedules. This includes added, deleted, and revised logic. A logic change includes lag and relationship changes. A print manager button 181 presents various printing options and settings, e.g., Microsoft Windows print settings available in products such as Microsoft Access for Microsoft Access.

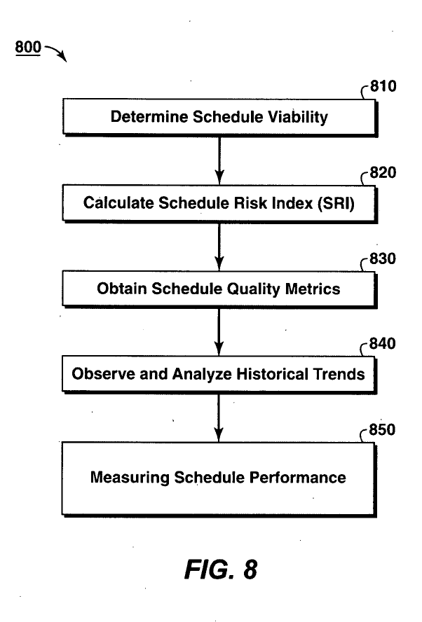

Referring to FIGS. 8-16, the techniques presented hereinafter with respect to embodiments of the present invention generally relate to one or more improvements relating to project scheduling. Specifically, the techniques presented hereinafter with respect to FIGS. 8-16 relate to one or more improvements with respect to assessing schedule viability via a float profile method, calculating schedule risk index scores, e.g., qualitative risk assessment, and/or assessing schedule quality, e.g., identifying measures of schedule quality. In addition, or alternatively, the techniques presented hereinafter with respect to FIGS. 8-16 also relate to historical trending throughout a project schedule, e.g., a system that captures key statistics and provides historical records to observe trends relating to schedule viability, risk, performance, and/or quality; and schedule performance, e.g., specifically measured by trending early starts and early finishes and the relative slippage occurring from one schedule update to another, e.g., which also may be trended over time as aforementioned.

One or more of the techniques presented hereinafter with respect to FIGS. 8-16 relate to the development of metrics useful for, and from the perspective of, the project owner assessing the performance of a scheduler, e.g., particularly a subcontractor performing schedule management for the project owner. For example, schedulers may not want managers or project owners knowing that short cuts have been implemented, and/or if mistakes have been made that may indicate an unqualified scheduler. Software companies also tend to focus training on how to use the software, and adding functionality based on user feedback and the ability to maximize sales.

Referring to FIG. 8, an exemplary process 800 for analyzing and managing a project schedule includes determining schedule viability 810, calculating schedule risk index (SRI) 820, obtaining schedule quality metrics 830, observing and analyzing historical trends throughout the project schedule 840, e.g., periodically during the life of the project, and measuring schedule performance 860. In step 810, a float profile area chart having a float profile with a float gradient is developed for at least one non-completed activity within the project schedule to pictorially assess schedule viability. In step 820, a schedule risk index (SRI) score is calculated to qualitatively assess a risk level associated with the project schedule. Calculating the schedule risk index score may include comparing changes from a recent schedule update relative to a previous schedule update based on a plurality of weighted factors to tabulate the SRI score. As described with respect to the system of the background art, the SRI score is indicative of risk the project schedule will miss a scheduled completion date.

In step 830, a plurality of schedule quality metrics are measured and the values aggregated for the metrics to provide an indication of the project schedule being manipulated by a scheduler. In step 840, historical trends are recorded for the schedule quality metrics across at least two update intervals. In step 850, schedule performance is measured by trending early starts and early finishes for the project and a relative slippage occurring from the previous schedule update to the recent schedule update. One of skill in the art will appreciate that one or more of each of the steps 810-850 of process 850 may be performed simultaneously and/or in various orders.

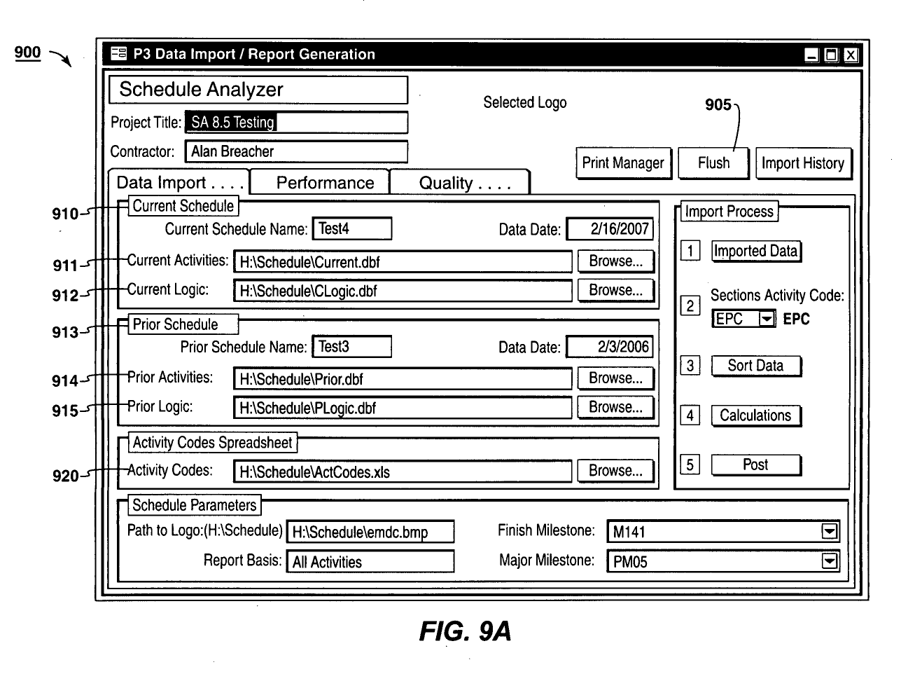

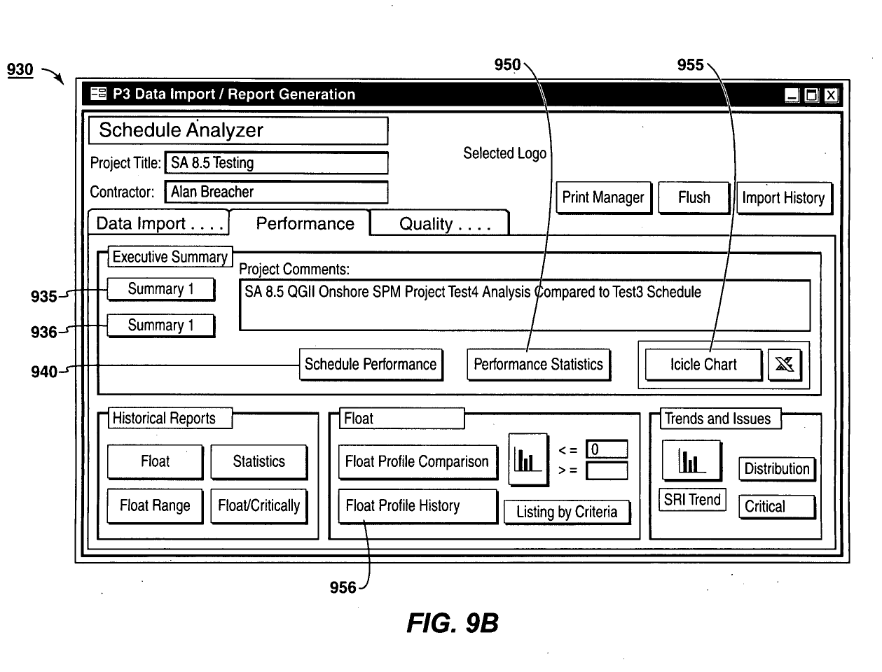

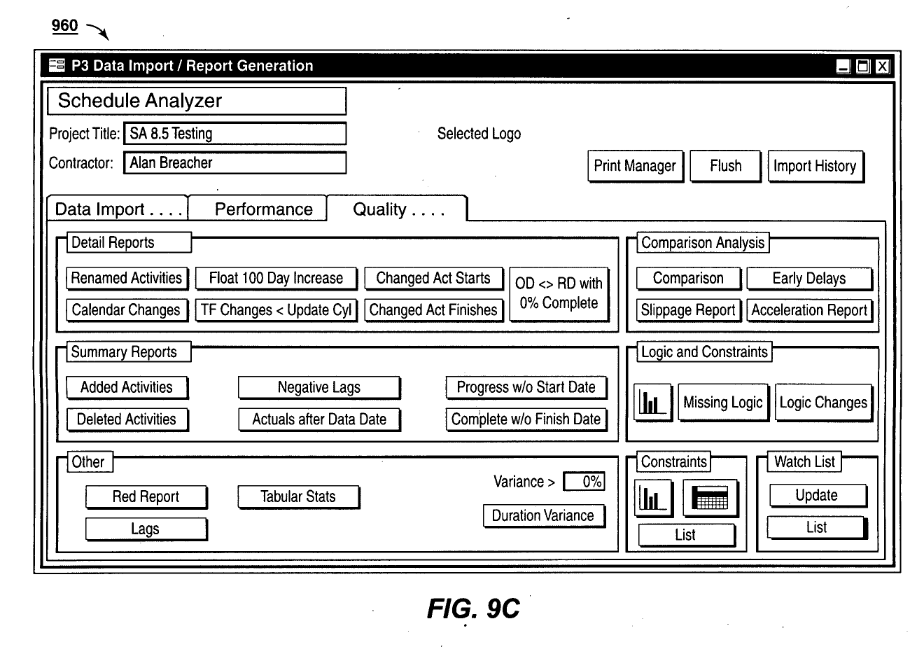

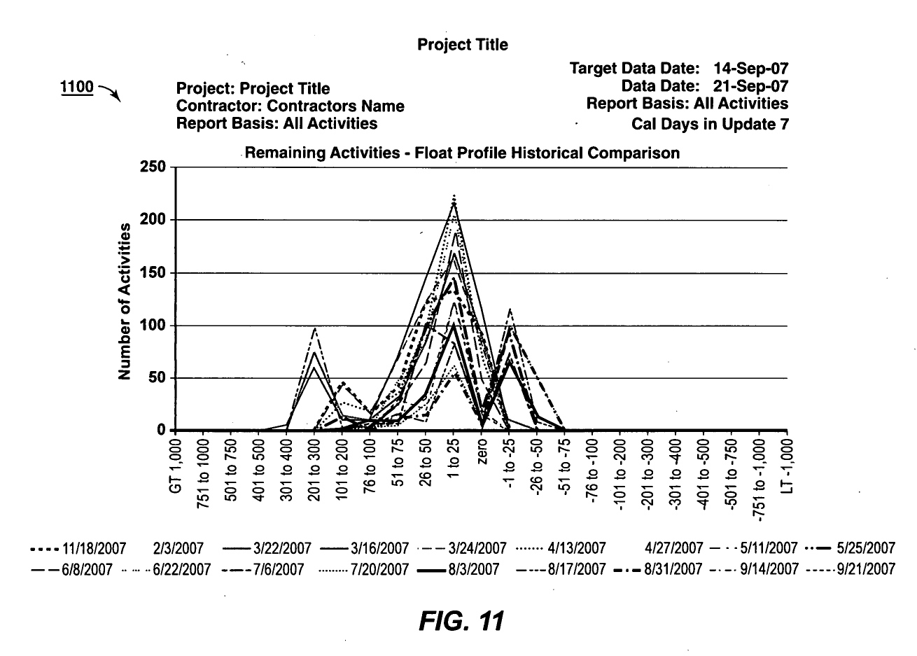

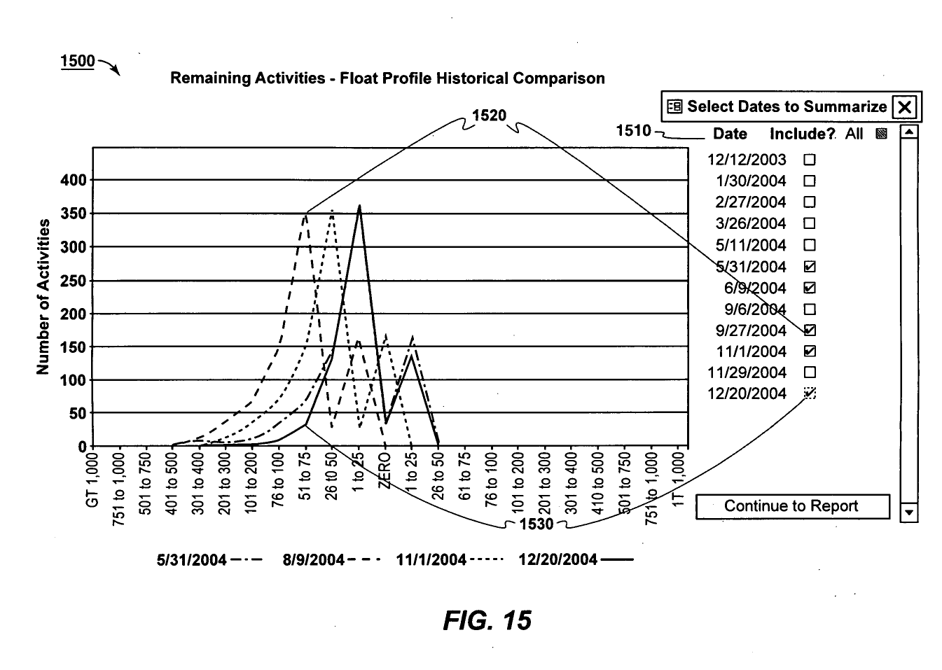

As described in greater detail hereinafter with respect to FIGS. 9A-9C through FIG. 18, the process 800 includes various features that improve upon analysis techniques of the background art in one or more ways. For example, the determination of schedule viability, calculation of SRI, and/or observing and analyzing of historical trends is performed periodically, e.g., at numerous times or at predefined or even random intervals, to better assess schedule quality and performance throughout the life of a project. Determining schedule viability 810 is accomplished through the use of historical float profiles, e.g., FIGS. 11 and 15. The float profile is directed at non-completed activities, e.g., for a particular point within a project, includes an area chart developed with positive float gradients filling the left quadrant range (from 1 to 1,000) days, the mid-point of 0 days float, and the right quadrant range of (−1 to −1,000) days. Float is a measure of how many days an activity may slip prior to impacting the scheduled completion. While float profiles have typically been provided for a current period and a target period or scheduling goal, a preferred embodiment involves the generation of multiple float profiles, e.g., at various times throughout the life of the project, to assess float and identify undesirable trends more quickly and accurately throughout the life of a project. Accordingly, float profiles are developed for a current period and a target period, for all historical periods and the current period, and float for all activities by activity type. The float profiles can then be displayed for historical ranges and/or through the use of date filters.

The schedule risk index (SRI) 820 is calculated to qualitatively assess a risk level using metrics to compare changes from one schedule update relative to the prior schedule update and tabulate a score. The level of risk, e.g., the likelihood the schedule will miss its scheduled completion date is determined by the range into which the calculated value falls. In contrast to the SRI calculated in the background art, the SRI is calculated as a value between 0 and 100, and with customized weighting of various metrics. For example, the level of schedule risk (SRI) is determined by the following ranges: 0 to 33.3 (low risk); 33.4 to 66.6 (medium risk); and 66.7 to 100 (high risk). In a preferred embodiment, the SRI is calculated from eleven factors and factor weightings. Most of the factors are calculated as a percentage of the remaining schedule activities. The exception to this is criticality, which is the number of days of negative float. After each factor is calculated, it is ranked on a scale of 1 to 3. The ranking is determined by three ranges: less than 10 percent, 10 percent to 50 percent, and greater than 50 percent. The ranked score for each factor is then multiplied by 33.3 to allow for plotting on a 100-point scale and then multiplied by a weighting percentage. All of the resulting “earned value” scores are then added together for the final SRI score. Based on the resulting score, the schedule risk will be classed as low, medium, or high.

In a preferred embodiment, the following eleven factors are used for the SRI calculations, with the respective weighting percentages shown in parenthesis. Early Start (ES) slippage (10%) measures the percentage of activities whose early start dates have slipped. The ratio of average number of ES days versus days in the period (5%) quantifies the severity of the ES slippage. The percentage of activities whose early finish dates have slipped is measured by Early Finish (EF) slippage (10%). The severity of the EF slippage is measured by the ratio of average number of EF days versus days in the period (5%). The percentage of remaining activities with less than 50 days of float (15%), and the percentage of remaining activities with less than or equal to 0 days of float (10%) captures the effect of float. The percentage of logic changes in the period versus total logic ties (10%) quantifies a percentage of logic that has changed during the period. Criticality (10%) is an indication of how much negative float (empirical) is present in the schedule, e.g., which jeopardizes the project completion. The percentage of duration increases of remaining activities (10%) and average number of days of duration increases versus days in the period (5%) captures the effect of duration increases based on the number of activities and the overall project duration. The percentage of constrained activities (10%) identifies when the schedule bypasses mathematical calculations and is overridden by the user.

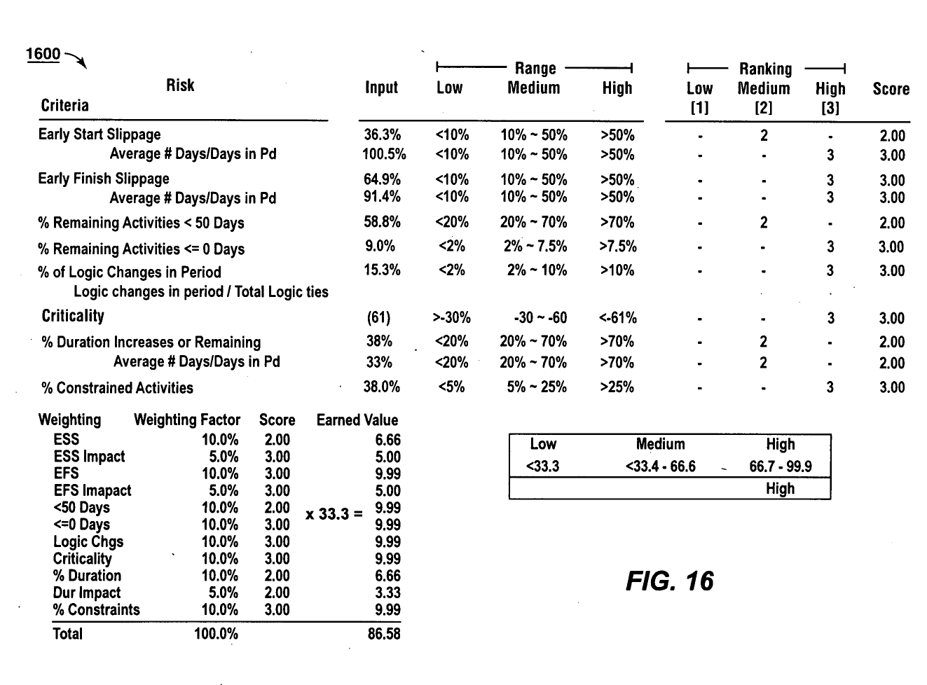

The SRI score is shown on various reports such as the Executive Summary reports and the Performance History report, as well as the SRI Trend report. Since the SRI score combines multiple performance factors, it provides a detailed indicator of overall schedule performance. A schedule that falls within the High category is likely to experience slippage and miss its target completion milestones. Referring to FIG. 16, an exemplary SRI calculation table 1600 provides an example where customized weighting of the aforementioned eleven factors results in an SRI of 86.58, e.g., a very high risk of delay. The factors that are included in the SRI calculations are described in more detail in the following numbered items.

Schedule quality metrics are obtained 830 by measuring various data points to assess the quality of the project schedule that is being analyzed. For scheduling software to accurate calculate and tabulate the data input, it is imperative that the quality of the input be high. In a preferred embodiment, the following ten different data points are measured to assess the quality of the schedule. Activity Duration Changes is a count of the number of non-started activities where the remaining duration of the non-started activities is different than the activities remaining duration. If the activity has not started, these two duration values should match, unless changed. Changing the activities remaining duration when it has not started is one method to manipulate the calculated schedule outcome. Recording progress to a Non-Started Activity, e.g., by recording progress 10% complete for an activity that has not started, is another way to manipulate the calculated schedule outcome. Recording an Actual Start/Finish after the schedule Data Date is another method to manipulate the calculated schedule outcome, which includes dating an activity to have actually started or completed in the future, e.g., later than the schedule data date. Recording 100% progress to an Incomplete Activity is a way of showing an activity 100% complete to manipulate the calculated schedule outcome so that scheduling software assumes the activity is complete, e.g., when the activity may not have been recorded as complete. The Number of Added or Deleted Activities is a metric that is monitored frequently, e.g., every month. It may be expected or normal to develop and refine the schedule early in the project; however, after several months, there should be minimal added or deleted activities. If the Number of Added or Deleted Activities is monitored every month, and in the later stages of a project, significant instances of adding/deleting activities is detected, the calculated schedule outcome may be being manipulated by the scheduler.

The Number of Revised Activity Descriptions, e.g., early on in a project it is expected to further develop and refine the schedule; however, after several months there should be relatively few revised activity descriptions. This schedule quality metric is monitored frequency, e.g., every month, and in the later stages of a project significant instances of revising activity descriptions may identify manipulation of the calculated schedule outcome. The Number of Logic Changes is also monitored frequently, e.g., every month, as there should also be minimal revisions to the schedule logic after several months. Significant instances of changing the schedule logic later in the project may also identify manipulation of the calculated schedule outcome. The Number of Calendar Changes may also be monitored frequently, e.g., monthly or with the other monthly updated schedule quality metrics at more frequent intervals and/or based on predetermined events. The Number of Actual Start Changes detects if a previously completed Actual Start date of an activity, e.g., a start date of Jan. 15, 2007, is different than in the succeeding month (or update interval), e.g., Feb. 15, 2007. If an activity start date is manipulated, the scheduler may be forward or back dating start dates to mask scheduling or activity delays. Similarly, the Number of Actual Finish Changes is also monitored. For example, if a previously completed Actual Finish date of an activity at a first update interval, e.g., Jan. 15, 2007, is different than in the succeeding interval, e.g., Feb. 15, 2007, the current actual finish is different than the prior month (changing history).

The monitoring of these ten (10) schedule quality metrics provides useful analysis and a way to assess the quality of the schedule as well as the scheduler working on the schedule. For example, significant instances of these varying tactics of schedule manipulation can provide a warning to the supervisor/project owner that the project schedule is being manipulated and the calculated schedule outcome should be suspect.

Historical trends are observed and analyzed 850 by performing multiple schedule updates, e.g., monthly, weekly, daily, randomly, event-driven, to capture historical information for each successive schedule update and tracking these changes over time. By tracking the historical information throughout the life of a project, root cause analysis of suspect scheduling can be performed to better determine when and/or how a project schedule has been manipulated. For example, by capturing these historical metrics, a project owner may better investigate manipulation, schedule jeopardy, and/or if addressing contract claims, e.g., and trying to perform a forensic analysis and investigation on a completed project for claims and/or litigation defense. With respect to the exemplary schedule quality metrics discussed hereinabove, many of the metrics, e.g., the Number of Actual Start Changes, the Number of Actual Finish Changes, require keeping information at each schedule update that is typically overwritten and/or was not previously recorded in systems of the background art. The unique historical trending of the present embodiments permit a previously completed Actual Finish date of an activity at a first update interval, e.g., Jan. 15, 2007, to be compared with data collected from other interval(s), e.g., Feb. 15, 2007, which may be different than the first update interval. Without the combination of historical trending of specific schedule quality metrics, various schedule manipulation techniques could go undetected by the project owner.

The capture of historical information will therefore typically include any of the aforementioned metrics described in connection with steps 810-850. In a preferred embodiment, one or more of the following data points, e.g., which may include one or more of each of the weighted factors, schedule quality metrics, and/or early start and early finishes for a project, are captured at each schedule update and recorded throughout the project life cycle. The update interval in a preferred embodiment may include monthly updates, which may be complemented by event-driven updates such as project delays or work stoppages, e.g., due to weather, or other instance requested by a project owner, e.g., to memorialize project status at a certain point in time. Each updates will typically include one or more of the following data points at each update interval. The Number of Added or Deleted Activities, and a Number of Logic Changes are recorded at each update. Early on in a project it is expected that the schedule will be developed and refined. However, after several months, there should be minimal added or deleted activities, and/or logic changes. For example, these metrics are monitored every month and in the later stages of project significant instances of adding/deleting activities, and/or schedule logic changes, typically identifies manipulation of the calculated schedule outcome. Activity Duration Changes is recorded, which is a count of the number of non-started activities where their remaining duration is different than the activities remaining duration. If the activity has not started these two values should match, unless changed, and changing this activities remaining duration when it has not started is one method to manipulate the calculated schedule outcome. Average of Duration Increase is calculated to identify all activities where the duration increased by counting increases in duration and then computing the average number of days. The Schedule Risk Index (SRI) is calculated and recorded at each update interval, e.g., as described in connection with process step 820. The Total Float (Maximum) for uncompleted activities, the Average Float, and/or Minimum Float—the minimum float value of all remaining activities to complete, e.g., quite often a negative number, are all recorded at each update interval. The total activities in the schedule versus the remaining activities to complete is calculated to gauge project completion based on activity counts. Near Critical activities are also grouped by Float ranges at each update interval, e.g., +1 to +20 days, 0 to −20 days, and less than (beyond) −20 days, to provide a focus on jeopardy of completing the project on time. [0064] Schedule performance is best measured 860 by observing and analyzing project execution (and any variance thereof), and may also be performed periodically at each schedule update. Specifically, the measuring of Early Starts (ES) and Early Finishes (EF) provides visibility of how well the project is going to the plan. An ES is the earliest moment in time that an activity can start and an (EF) is the earliest time that an activity may finish. Changes to the ES/EF from one schedule to the next schedule are significant, because if an activity slips, it is important to understand that activities are not being worked on or completed as planned. If more and more activities slip, any float in the project schedule is consumed and eventually large degrees of activity slippage results in the project being delayed in its entirety. This slippage is a leading indicator of contractor performance and a gauge of the likelihood of completing the project on schedule. The schedule analysis system develops this statistical data by comparing each activities data from one schedule to the next and calculating the slippage, then storing these values for historical trending. The ES/EF (slippage) performance metric, along with the other data points, e.g., schedule quality metrics and weighted factors, are also useful if performing schedule forensic analysis for claim assessment and or claims defense/litigation.

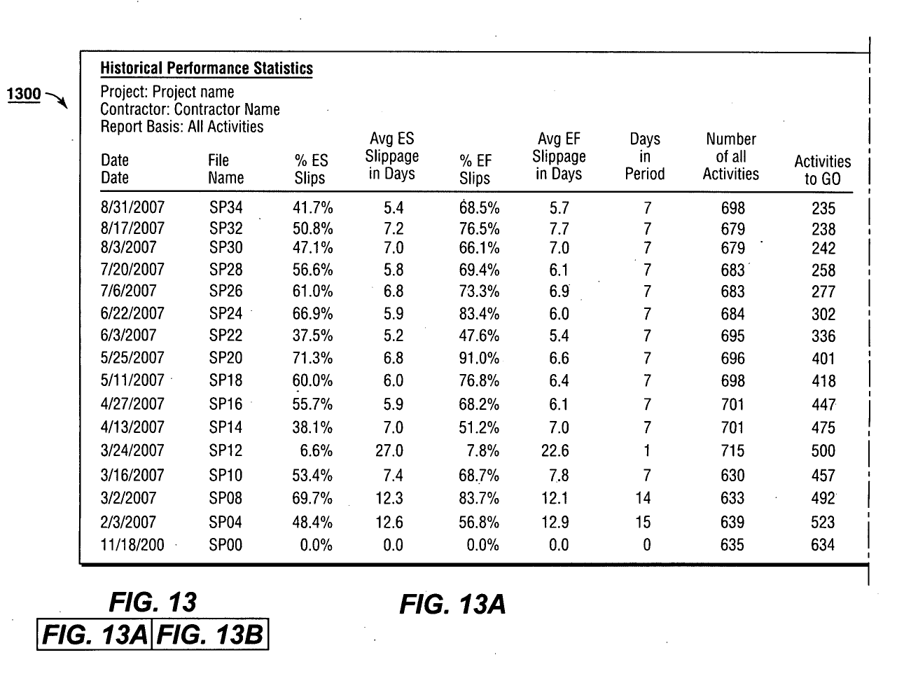

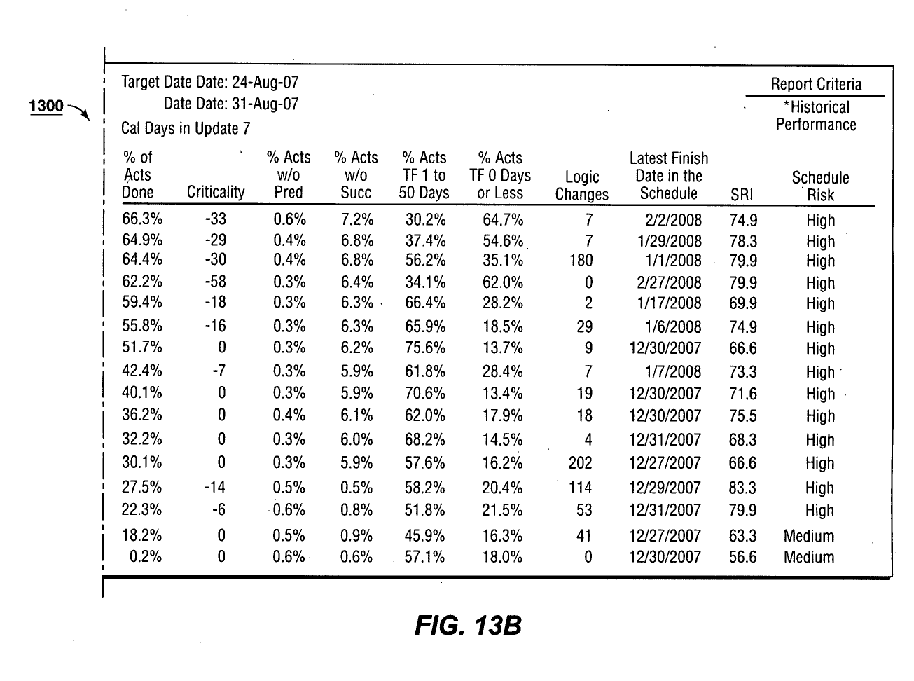

Referring to FIG. 13, another advantage of the improved historical trending of schedule risk, quality, and/or performance statistics in the present system (FIGS. 9A-9C), is that information may be accumulated and displayed on a tabular report 1300 which also provides key visibility to significant time frames of when major slippage in the end date occur and the build-up of these key statistics prior to the delay in project completion.

A number of embodiments have been described. Nevertheless, it will be understood that various modifications may be made without departing from the spirit and scope of the invention. For example, the schedule analysis system supports Critical Path Schedule (CPM) methodology by highlighting deficiencies within contractor schedules. A contractor schedule typically includes deficiencies that prohibit a scheduling program, such as Primavera Project Planner (P3), from providing its intended benefits. Schedule quality deficiencies typically include activities without logic connections, excessive float, negative lags, and so forth. Performance areas addressed include schedule slippage, acceleration, and manipulation of schedule data. In a preferred embodiment, the schedule analysis system is developed in Microsoft Access, e.g., providing report generation, user interface, and data importation and storage in a database, to have the ability to import schedule data exported from commercially available project and portfolio management software, such as Primavera Project Planner (P3) or similar scheduling software. By importing scheduling data, such as from P3, a scheduler can easily create reports for a contractor's schedule by comparing the current schedule with a target schedule. The schedule analyzer utilizes a series of reports and pictorial representations of the schedule quality, manipulation (if present), and schedule performance indicators, e.g., supported by MS Access or similar database tools.

Referring to FIGS. 9A-9C, a graphical user interface of the improved schedule analysis system includes three tabbed interfaces 900, 930, 960 that provide access to the schedule data importation and reporting features of the present system. With respect to interface 900, the data importation interface provides several advantages over the legacy system 100, e.g., section 120 of FIG. 1A. With respect to FIG. 9A, only features that are not common with the legacy system of FIG. 1A are identified with reference numerals. For example, the data importation interface 900 provides the ability to ensure that the database is free of pre-existing data by clicking the Admin button and then a Flush Database 905 button. The name of the project is entered in the Project Title field and the contractor's name is entered in the Contractor field. The name of the current schedule is also entered in the Current Schedule Name field and the corresponding data date in the Data Date field. Project names typically have a 4-character alphanumeric value. In the Prior Schedule fields, the name and data date for the project against which a comparison with the current project data is desired is entered by the project owner. If the project owner is establishing a baseline schedule, the same data date for both the prior and current schedules is entered. In all other situations, the system requires the project owner to enter different data dates for the prior and current schedules. For example, if the owner is re-establishing a baseline for an existing schedule that has the same data date as the previous schedule, the data date for the “prior” schedule is entered and a data date that is different by one day for the “current” schedule.

One advantage of comparing both current and previous schedules is to ensure that the schedule analysis system contains data through the last schedule and the current schedule. The current schedule section 910 includes fields for updating current database pathways for the current activities 911 and the current logic 912. The prior schedule section 913 includes fields for updating prior schedule database pathways for the previous activities 914 and the previous logic 915. The analysis system will compare the current schedule with the prior schedule when data importation is initiated. Accordingly, it is important that the data dates for previous and current schedules are entered correctly so that the system can accurately compare previous schedule data with current schedule data. The finish and major milestones used in the previous schedule analysis may still be in use in the current schedule. If different milestones are being used in the current schedule, these are entered in the Finish Milestone and Major Milestone fields. The pathway for an activity code spreadsheet 920, which permits the sorting of activities according to various activity codes, is also provided in the current system interface 900.

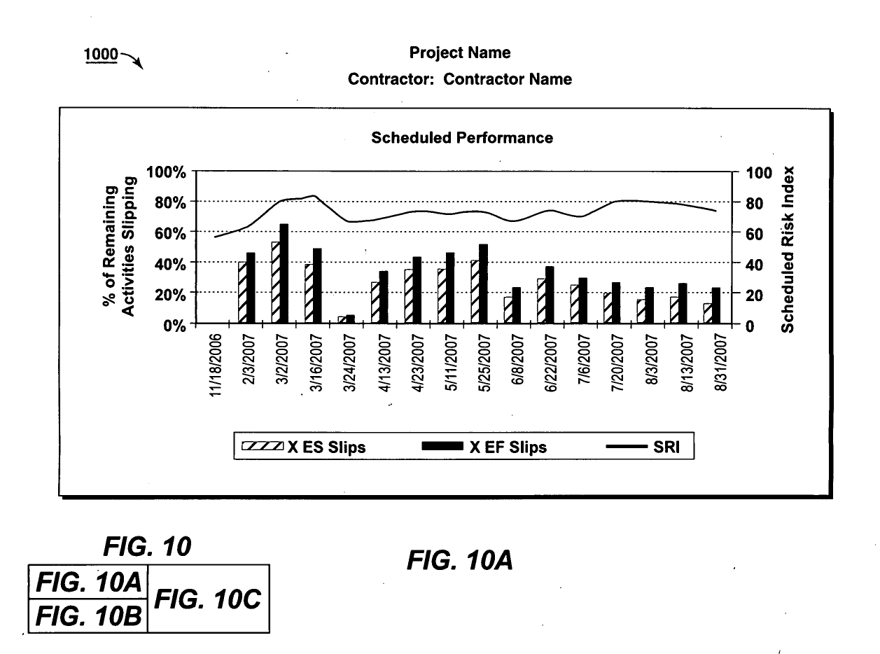

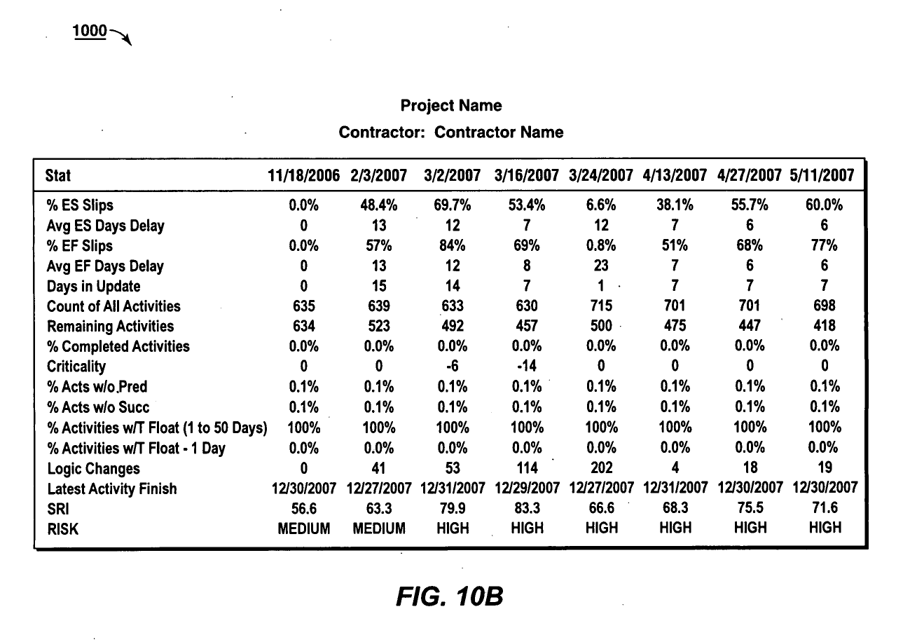

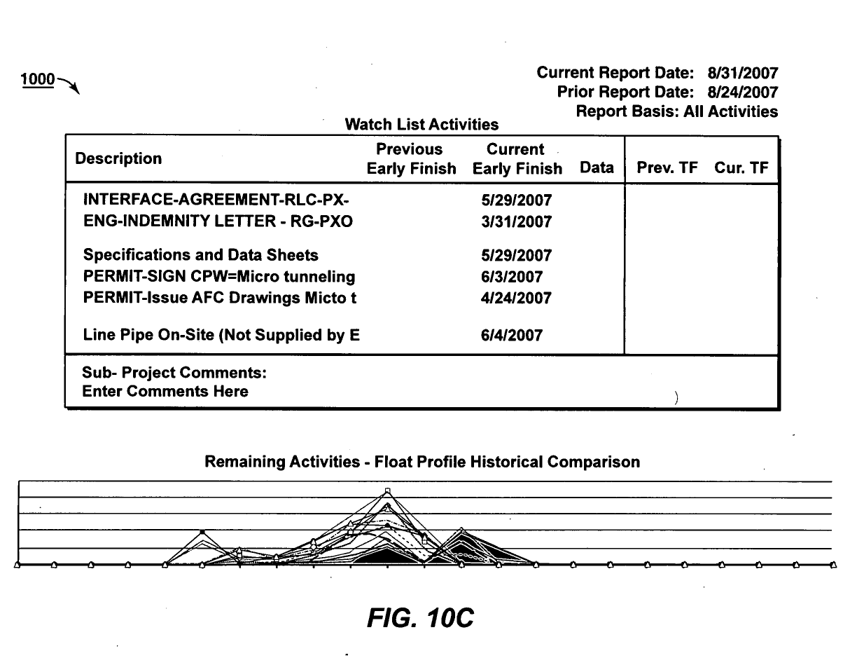

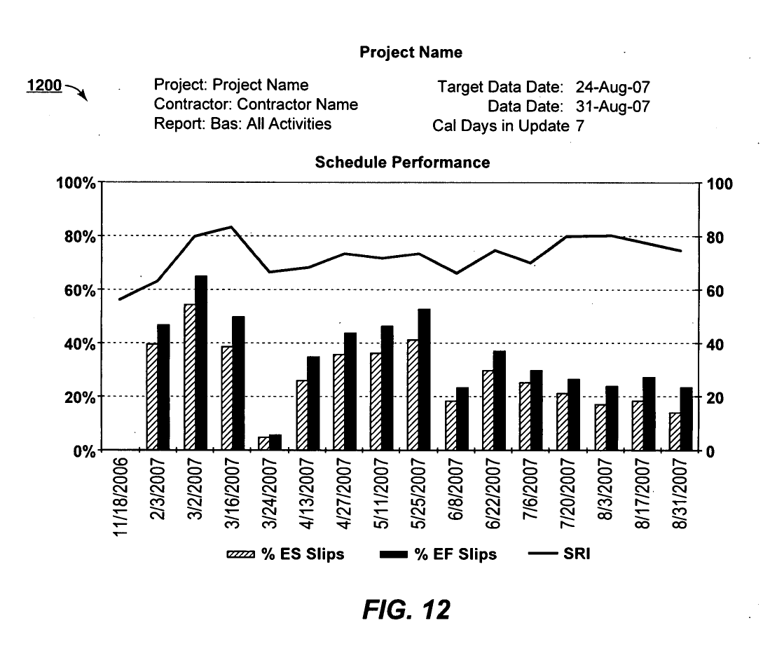

Referring to FIG. 9B, a schedule performance interface 930 includes radio buttons required to generate various types of reports. Reporting aspects of the legacy system of the background art that are present in the reporting capabilities of interfaces 900, 930, 960 are only briefly discussed and/or omitted hereinafter from the following discussion of the present embodiments. User interface 930 provides additional executive summary reporting features 935, 936, schedule performance reporting 940, and performance statistics 950, an icicle chart 955, and a float profile historical chart 956. With respect to the generation of executive Summary Reports, the interface 930 provides two summaries for reporting schedule performance, an Issues Summary report 935 (Summary 1), e.g., FIG. 10 chart 1000, and an Executive Summary 936 (Summary 2), e.g., FIG. 6, chart 600. These reports include statistics and charts from other reports, e.g., some legacy reports of the background art and some improved reporting techniques which each provide an overview of the schedule status. Unique features of the improved reporting techniques are described in further detail with respect to FIGS. 10-16. For example, referring to FIG. 12, the Schedule Performance button 940 displays the Schedule Performance report. The schedule performance report 1200 compares the ES/EF slips as a percentage of all activities with the overall SRI scores for each data period. Referring to FIG. 13, the Performance Statistics button 950 displays the Historical Performance Statistics report 1300. The Historical Performance Statistics report 1300 groups together various performance statistics such as ES/EF slips, average slippage in days, activities remaining, criticality, logic deficiencies, logic changes, SRI, and the risk category for each data date.

The Trends and Issues section of interface 930 provides three graphs that show areas of concern for the overall schedule stability and structure. The SRI Trend button produces the Schedule Risk Index (SRI) historical trend graph. This graph provides a qualitative indicator of the risk of schedule delay. It evaluates the schedule quality, extent of changes and/or manipulations in the schedule components, performance relative to the plan, and the stability of the plan. The Distribution button displays a Summary Distribution histogram showing the distribution of remaining activities by category. The left axis shows the count of remaining activities and the bottom axis shows the activity types. The histogram shows how many activities are complete, how many are in progress, and how many have not yet started. The report reflects progress by completed activities and indicates which category of activity is of most concern. The Criticality button displays a histogram that represents the criticality for the remaining activities (minimum total float) by activity type. This report helps the user to quickly identify the types of activity that are the most critical and need further investigation. Project Teams can use this report to determine which types of activity need the most resources to get the schedule back on track.

Referring to FIG. 9C, and the schedule quality interface 960, several features are provided in this interface. Similar to interface 930, the features common with the legacy system 150 of the Background Art are not labeled in FIG. 9C. However, the reporting features of each of these reports will benefit from the improved historical trending of the present system, e.g., the ability to capture historical data points throughout the project life to monitor changes in schedule quality 960 and performance 930 more accurately.

For example, the Red Report button in FIG. 9C provides a one-page summary report, e.g., the Red Report 500 of FIG. 5, of structural inefficiencies with the project. The Red Report 500 is a useful report that highlights inefficiencies in the schedule that may cause project slippage. The report summarizes schedule quality factors by providing the number of activities with the following characteristics: activity duration changes, progress without actual start dates, actual start and finish dates that occur after the schedule data date, completion without actual finish dates, added and deleted activities, revised activity descriptions, logic changes, calendar changes, actual start date changes, and actual finish date changes. These statistics are all plotted on other charts in more detail, but the Red Report 500 collects these statistics together in one chart to highlight those key factors that are typically indicators of project slippage, poor schedule design, and schedule manipulation.

The historical buttons (FIG. 9B) enable the capture and trending over time of high level summary statistics. The Float button displays the Float History report. The two graphs in this report compare the number of remaining activities with the trend for free float over time. The “Schedule Activities” graph compares the total number of activities with the remaining activities. This highlights sudden increases or decreases in activity numbers and shows progress towards the finish milestone in terms of the number of activities completed. A large increase in the number of activities may cause the schedule to slip by making it more difficult for the contractor to meet the finish milestone. The “Float History” graph shows how many of the remaining activities fall into each float range, with each range represented by a different line. The direction of each of the lines may have implications for schedule performance. For example, an increased number of activities with a greater number of float days suggest the schedule is becoming more critical.

The Statistics button displays a Historical Statistics Report. This chart collects together the following numerical statistics: added and deleted activities, logic changes, SRI scores, and duration increases, and plots them on a graph (one line for each statistic). The report also includes the name of each schedule and the risk category. The numbers in the “MaxOfAverage Change” row represents the change in the average number of days of duration for activities that have a longer duration than the same activities in the target schedule. The greater the number of duration changes, the greater the opportunity for schedule slippage. When compared, these statistics show whether a schedule is in the high risk category. A “bump” in the plotted lines—indicating sudden increases—suggests schedule manipulation and the probability of slippage, especially towards the end of a project.

The Float Range button provides a graphical report showing maximum, minimum, and average total float for each successive update. The Historical Total Float Range report plots the total float ranges (minimum, maximum, average) for all activities during the life of the project or for selected data dates. For each data period, the report shows the maximum and minimum days of float and the average days of float for all remaining activities. If the maximum days of float is very high or the minimum is very low (negative) then some further investigation of the corresponding activities may be required to determine the cause. The Float/Criticality button displays a graphic of the number of delayed activities and their criticality.

Referring to FIG. 9B, the Float Profile comparison provides an area chart comparing the current float profile with the prior schedule. In interface 930, the Float Profile History button 956 produces float profile historical comparisons providing additional details and reporting capabilities not available in the background art. Additional details of the improved reporting capabilities are discussed in greater detail with respect to FIGS. 10, 11, and FIG. 15.

Referring to FIG. 9C, a target comparison analysis selection provides four reports focused on schedule performance. The schedule performance is derived from comparing the current schedule against a “target” schedule. The Comparison button provides a statistical tabular report categorized by the Sections Activity Code. This report provides a wealth of information. The Slippage Report and Acceleration Report buttons display data entry forms (“Slippage Form: Form” and “Acceleration Form: Form”) in which the project owner enters activity information. Both forms contain Preview Report buttons that display the appropriate report for either slippage or acceleration. The Early Delays button produces a graphic focused on schedule realization and schedule performance for gauging the early schedule start and finish dates. To specify the output of the Slippage or Acceleration report, enter the number of days of schedule slippage for each date field. Enter a negative number for slippage and a positive number for acceleration.

Referring to FIG. 9C, the Tabular Stats button provides a summary statistical chart. A Lags button displays a report that lists the current, prior, and delta of the lags for all activities. The Renamed Activities button provides a tabular listing of the activity descriptions that have been changed for the current schedule compared with the prior schedule. The Calendar Changes button provides a tabular listing of the activities that have calendar changes compared with the prior schedule. The Watch List button allows for the tracking of certain activities. The Update button displays a data entry screen that allows the owner to enter the activity ID of the activities the owner wants to track. The List button provides a report of these activities. The constraints selections provide data regarding imposed constraints applied to the schedule activities. A chart, listing, and category summary are provided. The changed Activity Starts selection provides a tabular listing of the activities that have calendar changes in the current schedule. The Changed Activity Finishes selection provides a tabular listing of the activities where the finish dates have changed in the current schedule. The Original Duration not equal to Remaining Duration and not Started selection provides a tabular listing of the activities where the original duration is not equal to the remaining duration and the activity has not yet started.

The Total Float Changes Greater than One Hundred Days selection provides a tabular report listing the activities and their current total float versus prior “target” float and the variance in calendar days. The report is truncated to only list those activities with a float variance greater than one hundred days. The Duration variances selection provides a tabular report showing duration variances. The percent of duration is entered for the selection criteria in the input form, and then the Summary button is selected to produce the desired report.

Referring to FIG. 9B, a Total Float section provides a tabular report that is focused on duration variances. Enter the percent of duration for the selection criteria in the input form, and then select the Summary button to produce a tabular summary. The Chart button produces a graphic area chart and ignores the criteria. In the Summary Reports section of FIG. 9C, the Added Activities selection provides tabular reports focused on added activities. The Deleted Activities selection provides tabular reports that list those activities that have been deleted from the current schedule. The Negative Lags selection provides a tabular report that lists activities with negative lag values in the logic string. The Actuals After the Data Date selection provides tabular reports that list activities with actual start or finish dates that are later than the schedule's data date. The Progress without an Actual Start selection provides tabular reports that list activities that show progress but not actual start dates. The Complete without an Actual Finish selection provides tabular reports that list activities that show progress but not actual finish dates.

Referring to FIG. 9C, a Logic and Constraints section provides three reports. The Chart button provides a graphic reflecting each area of the schedule and the percent of activities that are missing logic. The Missing Logic and Logic Changes buttons provide tabular reports. The Logic Changes report lists all the logic changes that have occurred since the prior schedule. This includes added, deleted, and revised logic. A logic change includes lag and relationship changes. The Total Float Changes<The Update Cycle (detailed report section) selection provides a tabular listing of all activities where the total float variance is less than the number of days in the update cycle. This report reflects float acceleration or activities that are becoming more critical in nature.

Referring to FIG. 10, the executive summary report 1000 shown includes a Schedule Performance chart, such as FIG. 12, 1200, historical performance statistics chart, such as FIG. 13, 1300, and a Float Profile History chart, such as FIGS. 11 and 15, 1100 and 1500, respectively. This report may also include a list of activities that a project team is watching closely, e.g., based on a watch list created in the system, as shown in the watch list incorporated in report 1000.

Referring to FIG. 13, the historical performance statistics chart that may be included in the report of FIG. 10 shows the improved reporting capabilities of the present system, e.g., the how and when of schedule manipulation, quality, or performance indicators at each update interval. In prior systems of the background art, the historical trending of various data points was lost for the project owner. For example, at any schedule update, the current results are typically only compared to a single baseline. The present system affords the opportunity to preserve multiple snapshots of schedule performance, quality, and structure throughout the project life. In contrast, systems of the background art focus merely on schedule performance and therefore overlook issues relating to the structuring and modification of the schedule, e.g., from the perspective of the project owner gauging performance of contractors and project schedulers. Accordingly, the report 1300 lists the following performance statistics in a preferred embodiment to accurately represent performance across all update intervals. The Percentage of remaining activities that have ES/EF slips; the average number of days by which an ES/EF is delayed; the Number of days in the schedule update; the total number of activities in the schedule; the number of remaining activities; the percentage of activities that are complete; Criticality (the maximum amount of negative float for any activity); the percentage of remaining activities without predecessors or successors; the percentage of activities with total float between 1 and 50; the percentage of activities with total float less than 0; the number of logic changes during the comparison period; the latest finish date for the schedule; the overall SRI score; and the current risk category into which the schedule falls.

However, if display or reporting space, e.g., screen or paper, is limited, the report may not be able to display all of the performance statistics and the owner may be provided with a pop-up window, e.g., similar to FIG. 15 discussed below, that provides the owner may be prompted to limit the displayed columns for each update interval (rows displayed). Therefore, the same or different statistics can be displayed in full on the Historical Performance Statistics report 1300 or executive summary report (issues) 1000.

Referring to FIG. 11, an exemplary float profile history chart 1100 compares the total float for the current period with the float for the entire schedule history or selected data periods. In the example shown, eighteen different data update periods are represented by a float profiles for each period shown in font-coded styles, e.g., with various combinations of colors, dashed, dotted, and/or dashed-dotted. By comparing the float profile for each data date, this chart can show how the float profile has changed as the project has progressed. This comparison can be used to determine how the project compares with other, similar, projects, and whether it is likely to meet its original milestones. Each profile compares the number of activities with the days of float for all the remaining activities in the data period. If a chart shows the float profile is becoming more negative over time it is likely that activities will slip and the project will miss its finish milestones. A comparison of the float profile over the life of the project can show whether activities have had too much float as well as too little.

Referring to FIG. 12, an exemplary schedule performance chart 1200 compares SRI scores with the percentages of ES/EF slippage (as a percentage of all activities). The chart measures the trend of early starts and early finishes and compares the slippage from one period to the next over the life of the schedule. Generally, there is a correlation between the SRI and ES/EFs slips. For example, if there is an increase in the number of ES and/or EF slips, the SRI score will also increase. This indicates that increases in the numbers of ES/EF slippage usually increases risk of overall project slippage. The left axis shows percentages for the number of affected activities and the right axis shows numbers for the SRI scores. The bottom axis lists the date for each data period.

Referring to FIG. 13, the exemplary historical performance statistics report 1300 discussed in greater detail hereinabove presents multiple key performance statistics in a single report. The report provides a summary of the schedule performance over the life of the project or for selected data dates. The statistics may include various metrics, such as the percentage of activities having ES/EF slips, average number of days for ES/EF slips, number of days in the data period, activity counts, percentage of activities completed, logic changes and deficiencies (activities without predecessors or successors), total float percentages, and SRI scores and risk category. Features, such as Criticality (negative float) can be highlighted in different colors to emphasize importance of features. The performance statistics displayed in this report provide an indicator of whether a project is likely to stay on track and meet the schedule's original finish milestones.

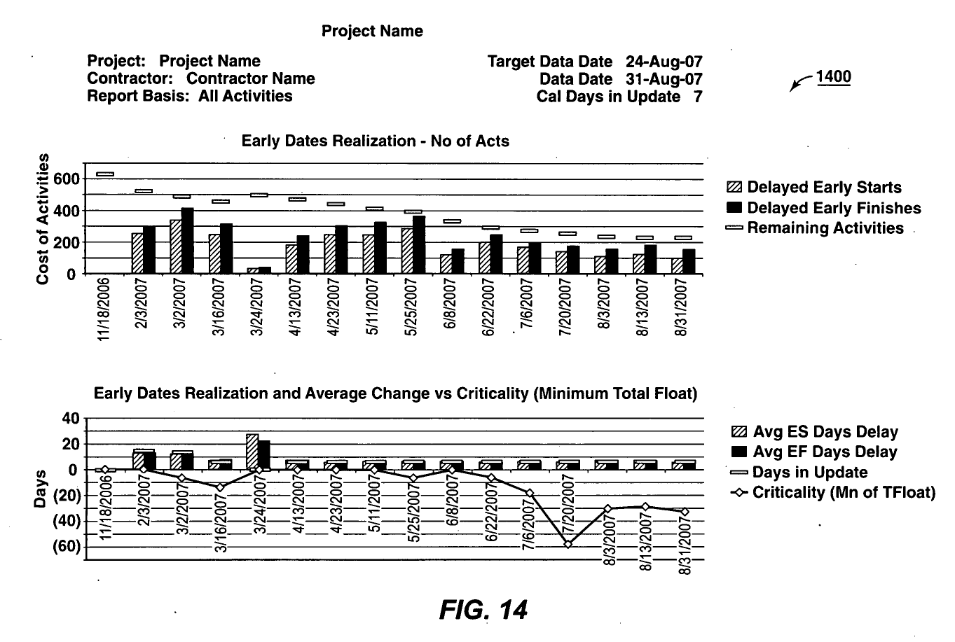

Referring to FIG. 14, an exemplary float criticality report 1400 includes two charts. The two charts in this report allow for comparisons to be made between the number of activities with delayed early starts and finishes, the number of remaining activities, average number of days represented by the delays, number of days in each data period, and the schedule criticality. The top chart shows a measure of schedule performance over the life of the project or for the selected data dates by comparing the number of delays (to early starts and early finishes) with the number of remaining activities. Post-Gate 3, increases to the number of activities as well as delayed activities may be a cause for concern.

The bottom chart shows the average number of days represented by the ES/EF delays for all activities and compares these delays with the number of days in the data period. For some schedules, the average number of days of delay may exceed the number of days in the data period. This may indicate very little progress was made during the comparison period. Any negative float (total float less than 0) will be plotted below the histogram. The graph looks at all activities in the schedule and plots the least amount of float. For example, if criticality is −14 (at least one activity has a negative float of 14 days), this will be plotted on the chart. Schedules with a high number of days of negative float are likely to slip when contractors do not have the resources to make the required productivity gains. The bottom chart suggests a possible relationship between the average ES/EF delays and the float criticality for the schedule activities. As activities are delayed they are more likely to have negative float and this increases the likelihood of project slippage.

Referring to FIG. 15, an exemplary float profile historical comparison chart 1500 is shown with an option window, e.g., pop-up window 1510, for designated a date filter for the various float profiles shown in the chart. By performing multiple schedule updates, the system is able to track float profiles for multiple periods so that any changes in float can be viewed to determine dates and magnitudes of any changes in schedule float. The ability to date filter reports, e.g., such as chart 1500 or chart 1300, is useful in emphasizing trends. For example, the project owner may first analyze data over numerous update intervals (such as with chart 100 in FIG. 11). After identifying update intervals with significant swings in project performance and/or quality, e.g., due to perceived schedule manipulation, the owner may regenerate reports by applying custom filters to show charts with only the desired update intervals, e.g., individual profiles selected with filters in pop-up window 1510 for several dates are shown in chart 1500. In chart 1500, only profiles for Sep. 27, 2004 and Dec. 20, 2004 update intervals are labeled, e.g., as 1520 and 1530, respectively.

Referring to FIG. 16, the exemplary SRI calculation table 1600 provides specific examples of the various weighted factors, e.g., process step 820 in FIG. 8, where customized weighting of the aforementioned eleven factors results in an SRI of 86.58, e.g., a very high risk of delay. The exemplary factors shown are included in the SRI calculations and are described in greater detail with respect to process 800 hereinabove.

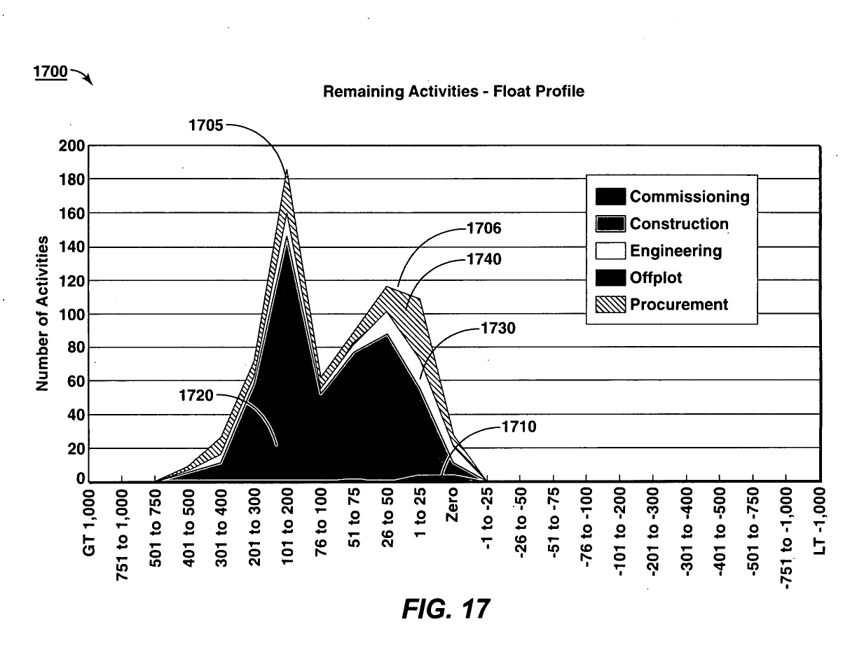

Referring to FIG. 17, a screenshot of an exemplary float profile chart 1700 includes float for remaining activities plotted according to various work groups 1710, 1720, 1730, and 1740. Float for remaining project activities, e.g., associated with field development and/or a production schedule for the production of hydrocarbons from a subsurface formation is plotted according to work groups, e.g., commissioning 1710, construction 1720, engineering 1730, and procurement 1740. The construction 1720, engineering 1730, and procurement 1740 work groups are spread over substantially the entire plot. Accordingly, chart 1700 is representative of missing logic ties for engineering 1730, procurement 1740, and construction 1720 activities. Further, a normal shape for float profiles would be a generally haystack appearance. The spikes or high points, 1705, 1706 collectively provide an abnormal profile, e.g., spike 1705 is indicative of poor schedule quality.

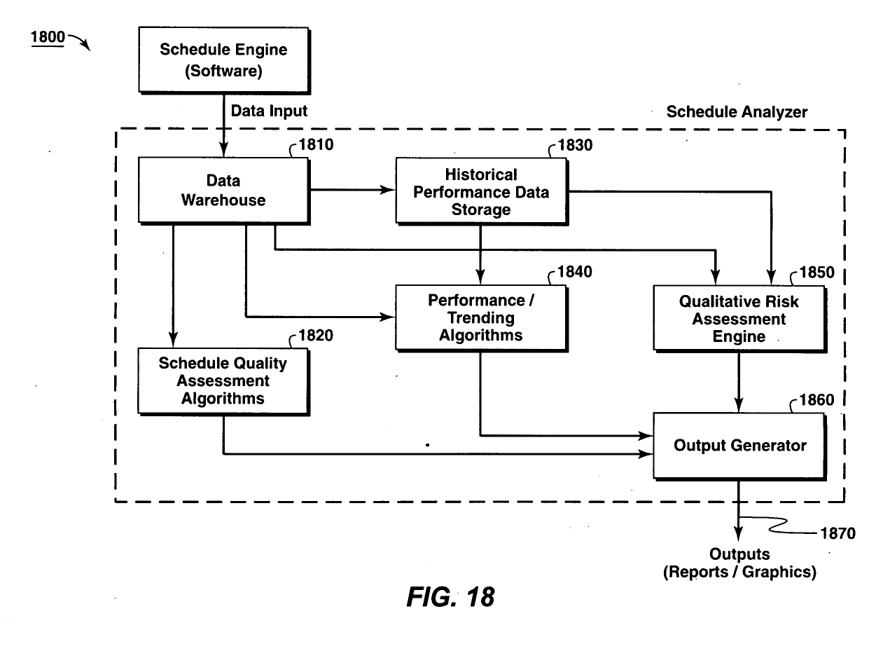

Referring to FIG. 8 and FIG. 18, an exemplary schedule analysis system 1800 includes one or more of the following features. For example, data importation and storage, data analysis, e.g., assessment and/or trending algorithms of one or more aspects of process 800, and report generation can be provided by system 1800. A commercially available scheduling engine 1810, e.g., Primavera Project Planner (P3) scheduling software, provides the information relative to a contractor's schedule and the project schedule's structure, activities, and progress. A data warehouse 1820, e.g., a combination a database with storage capability in memory coupled to a system processor, serves as an interface with the scheduling engine 1810 to import data and sort the data for processing and storage for various aspects of process 800. For example, schedule quality analysis (step 830) is performed by a schedule quality assessment component 1820 which implements algorithms necessary for this analysis. An historical performance data storage component 1830 provides the ability to store data and metrics for each schedule update, e.g., step 840. A performance trending component 1840 provides any performance trending algorithms necessary to implement step 850. A qualitative risk assessment engine 1850 supports the schedule risk index (SRI) calculations of step 820. An output generator 1860 integrates instructions, e.g., received through interfaces 900, 930, and 960, received from a project owner to output trends, reports, graphics, and charts either graphically, e.g., on a display component 1870 and/or in paper format, e.g., printed reports.

One or more of the aforementioned processes and/or techniques, e.g., such as the analysis of a schedule quality and schedule performance for a hydrocarbon field development and/or production schedule, can be implemented in digital electronic circuitry, or in computer hardware, firmware, software, or in any combination thereof. Any of the aforementioned functionality may be implemented as a computer program product, e.g., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

One or more process steps of the invention can be performed by one or more programmable processors executing a computer program to perform functions of the invention by operating on input data and generating output. One or more steps can also be performed by, and an apparatus or system can be implemented as, special purpose logic circuitry, e.g., an FPGA (field programmable gate array) or an ASIC (application-specific integrated circuit). In addition, data acquisition and display may be implemented through a dedicated data collection and/or processing system, e.g., containing data acquisition software/hardware, such as Microsoft Access residing on a computer and arranged to import data from a scheduling system, e.g., Primavera Project Planner, a processor(s), and various user and data input and output interfaces, such as a display component for graphically displaying one or more of the generated reports obtained through any of the aforementioned process steps or processes.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include forms of non-volatile memory, including by way of example semiconductor memory devices, e.g., EPROM (erasable programmable read-only memory), EEPROM (electrically erasable programmable read-only memory), and flash memory devices; magnetic disks, e.g., internal hard disks or removable disks; magneto-optical disks; and CD-ROM (compact disk read-only memory) and DVD-ROM (digital versatile disk read-only memory) disks. The processor and the memory can be supplemented by, or incorporated in special purpose logic circuitry.

All such modifications and variations are intended to be within the scope of the present invention, as defined in the appended claims. Persons skilled in the art will also readily recognize that in preferred embodiments, at least some of the method steps method are performed on a computer, e.g., the method may be computer implemented. In such cases, the resulting reports, metrics, and historical data may either be downloaded or saved to computer memory.

What is claimed is:

1. A method for managing a project schedule, said method comprising:
developing a float profile area chart having a float profile with a float gradient for at least one non-completed activity within the project schedule to pictorially assess schedule viability;
calculating a schedule risk index (SRI) score to qualitatively assess a risk level associated with the project schedule, wherein calculating the schedule risk index score includes comparing changes from a recent schedule update relative to a previous schedule update based on a plurality of weighted factors to tabulate the SRI score, the SRI score being indicative of risk the project schedule will miss a scheduled completion date;
measuring a plurality of schedule quality metrics and aggregating the values for the metrics to provide an indication of the project schedule being manipulated by a scheduler;
recording historical trends for the schedule quality metrics and weighted factors across at least two update intervals; and
measuring schedule performance by trending early starts and early finishes for the project and a relative slippage occurring from the previous schedule update to the recent schedule update.

2. The method of claim 1, wherein the float gradient is a measure of a number of days an activity may miss a target deadline prior to impacting a scheduled completion of the project schedule.

3. The method of claim 2, wherein the float profile area chart includes a first axis defining positive and negative float gradients and a second axis defining a number of activities defined along a second axis of the area chart.

4. The method of claim 3, wherein the float profile area chart includes a float profile having all non-completed activities plotted against float gradient, the float gradient including a positive float gradient range expressed from 1 to 1,000 days, a mid-point of zero days float, and negative gradient range expressed from −1 to −1,000 days.

5. The method of claim 2, wherein developing the float profile area chart includes displaying a float profile for a current period and a float profile for a target period.

6. The method of claim 2, wherein developing the float profile area chart includes displaying a float profile for a historical period and a float profile for a current period.

7. The method of claim 2, wherein developing the float profile area chart includes displaying float profiles for activities grouped by activity type.

8. The method of claim 1, wherein developing the float profile area chart includes displaying a float profile for each of at least three time periods during the project schedule.

9. The method of claim 1, further comprising wherein the score is a schedule risk index score within a range of 0 to 100, wherein a schedule risk index score of 100 corresponds to a highest risk of the project schedule missing a scheduled completion date.

10. The method of claim 1, further comprising displaying the schedule risk index score in a graphical report along with the float area profile chart.

11. The method of claim 1, wherein the weighted factors include one or more of the factors selected from the group consisting of (i) Early Start (ES) date slippage expressed in terms of percentage of remaining activities; (ii) Severity of ES slippage expressed in terms of average number of ES days with respect to days in the period; (iii) Early Finish (EF) date slippage expressed in terms of percentage of remaining activities; (iv) Severity of EF slippage expressed in terms of average number of EF days with respect to days in the period; (v) Percentage of remaining activities having 50 or fewer days of float; (vi) Percentage of remaining activities having less than or equal to 0 days of float; (vii) Percentage of logic changes changed in the period with respect to total logic ties; (viii) Criticality expressed in terms of negative float; (ix) percentage of duration increases of remaining activities; (x) Average number of days of duration increases with respect to days in the period; and (xi) Percentage of constrained activities associated with the schedule bypassing mathematical calculations.

12. The method of claim 11, wherein the weighted factors include three to eleven of factors (i) through factors (xi).

13. The method of claim 12, wherein the weighted factors include all eleven of factors (i) through (xi).

14. The method of claim 13, wherein the weighted factors are determined by multiplying values associated with factors (i) through (xi) by the following weighting percentages (i) 10%; (ii) 5%; (iii) 10%, (iv) 5%; (v) 15%; (vi) 10%; (vii) 10%; (viii) 10%, (ix) 10%; (x) 5%; and (xi) 10%, respectively.

15. The method of claim 1, displaying the SRI score for each schedule update on at least one report, wherein the at least one report also includes one or more of a float area profile chart, measured schedule quality metrics, recorded historical trends for the schedule quality metrics, early starts and early finishes for the project, and a relative slippage occurring from the previous schedule update to the recent schedule update.

16. The method of claim 1, identifying measures of schedule quality includes measuring at least one of the metrics selected from the group consisting of: (i) Activity Duration Changes; (ii) Progress Reported to a Non-Started Activity; (iii) Recording an Actual Start/Finish after the schedule Data Date; (iv) Recording 100% progress to an Incomplete Activity; (v) Number of Added or Deleted Activities; (vi) Number of Revised Activity Descriptions; (vii) Number of Logic Changes; (viii) Number of Calendar Changes; (ix) Number of Actual Start Changes; and (x) Number of Actual Finish Changes.

17. The method of claim 16, wherein the metrics include all ten of metrics (i) through metrics (x).

18. The method of claim 16, further comprising:
updating the project schedule during at least three project schedule updates; and
measuring and recording the schedule quality metrics at each project schedule update.

19. The method of claim 18, further comprising:
tracking changes in the project schedule quality over time; and
generating a tabular report indicative of changes in the project schedule at each project schedule update.

20. The method of claim 19, wherein one or more of the following metrics selected from the group consisting of: (i) number of added or deleted activities; (ii) number of logic changes; (iii) activity duration changes; (iv) average of duration increase; (v) schedule risk index (SRI); (vi) total float (maximum); (vii) average float; (viii) minimum float; (ix) total activities in the schedule versus remaining activities to complete; and (x) grouping of near critical activities by float ranges, are captured at each of the at least three project schedule updates and generated in the tabular report.

21. The method of claim 19, wherein one or more of the following metrics are captured at each of the at least two project schedule updates and generated in the tabular report: (i) early starts (ES); and early finishes (EF).

22. The method of claim 19, wherein the project schedule is associated with one or more of field development or production of hydrocarbons from a subsurface formation.

23 A tangible computer-readable storage medium having embodied thereon a computer program configured to, when executed by a processor, manage a project schedule, the medium comprising one or more code segments configured to:
develop a float profile area chart having a float profile with a float gradient for at least one non-completed activity within the project schedule to pictorially assess schedule viability;
calculate a schedule risk index (SRI) score to qualitatively assess a risk level associated with the project schedule, wherein calculating the schedule risk index score includes comparing changes from a recent schedule update relative to a previous schedule update based on a plurality of weighted factors to tabulate the SRI score, the SRI score being indicative of risk the project schedule will miss a scheduled completion date;
measure a plurality of schedule quality metrics and aggregating the values for the metrics to provide an indication of the project schedule being manipulated by a scheduler;
record historical trends for the schedule quality metrics and weighted factors across at least two update intervals; and
measure schedule performance by trending early starts and early finishes for the project and a relative slippage occurring from the previous schedule update to the recent schedule update.

24. The tangible computer-readable storage medium of claim 23, the medium further comprising one or more code segments configured to update the project schedule during at least three project schedule updates; and measuring the schedule quality metrics at each project schedule update.

25. The method of claim 23, further comprising tracking changes in the project schedule quality over time; and generating a tabular report indicative of changes in the project schedule at each project schedule update.

26. A system for managing a project schedule, comprising:
a processor;
a display unit operatively coupled to the processor; and
a memory operatively coupled to the processor, the processor being configured to:
develop a float profile area chart having a float profile with a float gradient for at least one non-completed activity within the project schedule to pictorially assess schedule viability through the display unit;
calculate a schedule risk index (SRI) score to qualitatively assess a risk level associated with the project schedule, wherein calculating the schedule risk index score includes comparing changes from a recent schedule update relative to a previous schedule update based on a plurality of weighted factors to tabulate the SRI score, the SRI score being indicative of risk the project schedule will miss a scheduled completion date;
measure a plurality of schedule quality metrics and aggregating the values for the metrics to provide an indication of the project schedule being manipulated by a scheduler;
record historical trends for the schedule quality metrics and weighted factors across at least two update intervals; and
measure schedule performance by trending early starts and early finishes for the project and a relative slippage occurring from the previous schedule update to the recent schedule update.
